(19) United States
(12) Patent Application Publication
(10) Pub. No.: US 2024/0311577 A1
(43) Pub. Date: Sep. 19, 2024

(54) PERSONALIZED MULTI-RESPONSE DIALOG GENERATED USING A LARGE LANGUAGE MODEL

(71) Applicant: GOOGLE LLC, Mountain View, CA (US)

(72) Inventors: Anoop K. Sinha, Palo Alto, CA (US); Quoc Le, Sunnyvale, CA (US); Jason S. Spielman, Los Altos, CA (US)

(21) Appl. No.: 18/364,355

(22) Filed: Aug. 2, 2023

Related U.S. Application Data
(60) Provisional application No. 63/453,711, filed on Mar. 21, 2023.
(60) Provisional application No. 63/451,923, filed on Mar. 13, 2023.

(51) Int. Cl. G06F 40/35

(52) U.S. Cl. CPC G06F 40/35

(57) ABSTRACT

Techniques are described herein for personalized multi-response dialog generated using one or more large language models. A method includes: receiving first natural language (NL) based input associated with a client device; generating, based on the first NL based input and using at least one large language model (LLM), one or more instances of first LLM output; determining, based on the one or more instances of first LLM output, at least three responses to the first NL based input; determining, based on at least one scoring criterion, respective scores of the at least three responses to the first NL based input; selecting, based on the respective scores of the at least three responses to the first NL based input, from the at least three responses to the first NL based input, a first subset, the first subset comprising at least two responses to the first NL based input; and causing each of the at least two responses in the first subset to be rendered at the client device.

### BACKGROUND

Large language models (LLMs) are particular types of machine learning models that can perform various natural language processing (NLP) tasks, such as language generation, machine translation, and question-answering. These LLMs are typically trained on enormous amounts of diverse data including data from, but not limited to, webpages, electronic books, software code, electronic news articles, and translation data. Accordingly, these LLMs leverage the underlying data on which they were trained in performing these various NLP tasks. For instance, in performing a language generation task, these LLMs can process a natural language (NL) based input that is received from a client device, and generate a NL based output that is responsive to the NL based input and that is to be shown at the client device. In generating the NL based output utilizing these LLMs, the same model inference pathway may be used for each user. However, using the same model inference pathway may not account for the different preferences among users. This may prolong user interactions with LLMs, decrease usability of LLMs, and detract from a user experience with LLMs.

### SUMMARY

Implementations described herein relate to personalized multi-response dialog generated using one or more large language models (LLMs). By learning pathways from individual user input and usage, implementations use personalized preference models for LLMs, e.g., LLMs used for conversational dialog systems such as chatbots. The trained personalized preference models may be used to provide an improved and highly personalized experience using LLMs. Implementations provide a chatbot that provides, to users, multiple responses to natural language (NL) based input. By allowing users to select a preferred response from the multiple responses, implementations provide users with control of alternative pathways through a dialog. Implementations utilize a user's selection of responses in a dialog to create and train a personalized preference model associated with the user.

In some implementations, in a conversational dialog system (e.g., a chatbot), the system presents a user who inputs a prompt (e.g., NL based input) multiple options for responses. One or more LLMs is used to generate multiple responses in the course of generation. Generation predicts the multiple response options based on the sequence prediction objectives. These multiple options can show variety-short responses, long responses, responses in certain styles, etc. Those multiple response options are presented in the user interface for the user to choose from.

In some implementations, upon choosing a particular response option, that response option is used as the going forward context in the conversation. For example, if a user wants to write a letter of apology, the response option that they select will be used for subsequent dialogs going forward.

In some implementations, a personalization signal is identified based on user preferences during a session and the responses that were selected by the user. The choices that were made in aggregate are used in training a scoring (ranking) model used for selection of the various response options. In some implementations, the system uses the preferences that were selected by a user to train a personalization model that is then used to further personalize subsequent responses generated using the LLM.

In some implementations, this personalization model learns the user's preferences with respect to length, style, and other aspects of their input. In some implementations, the personalization model may also be integrated with personal information, e.g., the user's frequent contacts, contacts that the user refers to by specific names, favorite sports teams, and/or other personal details.

In some implementations, in addition to being used in a chatbot context, the system may be used in any other contexts in which large language models are used, e.g., word processing applications, creation of emails, and other areas.

In some implementations, the personalization model used in conjunction with the LLM provides users with a more individualized experience and improves the functioning of conversational dialog systems and other systems using one or more LLMs. Accordingly, in some implementations, user interactions with these LLMs may be made more efficient, thereby conserving computational resources for the human-to-computer interaction, and a user experience with these LLMs may be improved. For example, some implementations may provide improved responses to user queries, therefore reducing the need for users to follow up with additional queries and reducing a duration of a user's interaction with a computing device, thereby conserving processing resources.

In some implementations, an LLM can include at least hundreds of millions of parameters. In some of those implementations, the LLM includes at least billions of parameters, such as one hundred billion or more parameters. In some additional or alternative implementations, an LLM is a sequence-to-sequence model, is Transformer-based, and/or can include an encoder and/or a decoder. One non-limiting example of an LLM is GOOGLE'S Pathways Language Model (PaLM). Another non-limiting example of an LLM is GOOGLE'S Language Model for Dialogue Applications (LaMDA).

In various implementations, a method implemented by one or more processors may include: receiving first natural language (NL) based input associated with a client device; generating, based on the first NL based input and using at least one large language model (LLM), one or more instances of first LLM output; determining, based on the one or more instances of first LLM output, at least three responses to the first NL based input; determining, based on at least one scoring criterion, respective scores of the at least three responses to the first NL based input; selecting, based on the respective scores of the at least three responses to the first NL based input, from the at least three responses to the first NL based input, a first subset, the first subset including at least two responses to the first NL based input; and causing each of the at least two responses in the first subset to be rendered at the client device.

In some implementations, the method further includes: receiving user input associated with the client device, the user input indicating a user selection of a particular response, the user selection being from among the first subset and being in response to rendering of the first subset at the client device; and in response to receiving the user input indicating the user selection of the particular response, identifying a personalization signal based on the particular response.

In some implementations, the method further includes: receiving second NL based input associated with the client device; generating, based on the personalization signal and the second NL based input, and using the at least one LLM, one or more instances of second LLM output; and determining, based on the one or more instances of second LLM output, at least three responses to the second NL based input. In some implementations, the personalization signal is used, along with the second NL based input, in generating the one or more instances of second LLM output, in response to identifying the personalization signal in response to receiving the user input indicating the user selection of the particular response.

In some implementations, the method further includes: determining, based on the at least one scoring criterion, respective scores of the at least three responses to the second NL based input; selecting, based on the respective scores of the at least three responses to the second NL based input, from the at least three responses to the second NL based input, a second subset, the second subset including at least two responses to the second NL based input; and causing each of the at least two responses in the second subset to be rendered at the client device.

In some implementations, the method further includes: modifying, based on the personalization signal, the at least one scoring criterion; determining, based on the at least one modified scoring criterion, respective scores of the at least three responses to the second NL based input; selecting, based on the respective scores of the at least three responses to the second NL based input, from the at least three responses to the second NL based input, a second subset, the second subset including at least two responses to the second NL based input; and causing each of the at least two responses in the second subset to be rendered at the client device.

In some implementations, the method further includes: receiving second NL based input associated with the client device; generating, based on the second NL based input, and using the at least one LLM, one or more instances of second LLM output; determining, based on the one or more instances of second LLM output, at least three responses to the second NL based input; modifying, based on the personalization signal, the at least one scoring criterion; determining, based on the at least one modified scoring criterion, respective scores of the at least three responses to the second NL based input; selecting, based on the respective scores of the at least three responses to the second NL based input, from the at least three responses to the second NL based input, a second subset, the second subset including at least two responses to the second NL based input; and causing each of the at least two responses in the second subset to be rendered at the client device. In some implementations, the personalization signal is used in modifying the at least one scoring criterion, in response to identifying the personalization signal in response to receiving the user input indicating the user selection of the particular response.

In some implementations, the method further includes: receiving second NL based input associated with the client device; modifying the second NL based input, based on the personalization signal, to generate modified NL based input; generating, based on the modified NL based input, and using the at least one LLM, one or more instances of second LLM output; and determining, based on the one or more instances of second LLM output, at least three responses to the second NL based input.

In some implementations, the method further includes: determining, based on the at least one scoring criterion, respective scores of the at least three responses to the second NL based input; selecting, based on the respective scores of the at least three responses to the second NL based input, from the at least three responses to the second NL based input, a second subset, the second subset including at least two responses to the second NL based input; and causing each of the at least two responses in the second subset to be rendered at the client device.

In some implementations, the method further includes: modifying, based on the personalization signal, the at least one scoring criterion; determining, based on the at least one modified scoring criterion, respective scores of the at least three responses to the second NL based input; selecting, based on the respective scores of the at least three responses to the second NL based input, from the at least three responses to the second NL based input, a second subset, the second subset including at least two responses to the second NL based input; and causing each of the at least two responses in the second subset to be rendered at the client device.

In some implementations, generating the one or more instances of first LLM output includes: processing the first NL based input, using a first LLM, to generate a first instance of the one or more instances of first LLM output; and processing the first NL based input, using a second LLM, to generate a second instance of the one or more instances of first LLM output; and determining the at least three responses to the first NL based input includes: determining, based on the first instance, a first response to the first NL based input; and determining, based on the second instance, a second response to the first NL based input.

In some implementations, generating the one or more instances of first LLM output includes processing the first NL based input, using a first LLM, to generate a first instance of the one or more instances of first LLM output; and determining the at least three responses to the first NL based input includes: determining, based on the first instance, a first response to the first NL based input; determining, based on the first instance, a second response to the first NL based input; and determining, based on the first instance, a third response to the first NL based input.

In some implementations, generating the one or more instances of first LLM output includes: processing the first NL based input, using a first LLM, to generate a first instance of the one or more instances of first LLM output; modifying the first NL based input to generate modified NL based input; and processing the modified NL based input, using the first LLM, to generate a second instance of the one or more instances of first LLM output; and determining the at least three responses to the first NL based input includes: determining, based on the first instance, a first response to the first NL based input; and determining, based on the second instance, a second response to the first NL based input.

In some implementations, modifying the first NL based input to generate the modified NL based input includes modifying the first NL based input to bias towards at least one response characteristic. In some implementations, the at least one response characteristic includes a tone (e.g., serious, sarcastic, silly, formal, informal, etc.) of a response. In some implementations, the at least one response characteristic includes a length of a response (e.g., 2-3 sentences, a longer paragraph, multiple paragraphs, etc.). In some implementations, the at least one response characteristic includes a complexity of a response (e.g., fourth grade reading level, college reading level, assuming no knowledge of topic, assuming expert-level knowledge of topic, etc.).

In some implementations, the at least one scoring criterion includes a diversity measure that is based on a level of distinctiveness relative to other ones of the at least three responses to the first NL based input.

In some implementations, the method further includes: receiving user input associated with the client device, the user input indicating a user selection of a modified response, the modified response selected by the user being a version of a response in the first subset that has been modified by the user, and the user selection being in response to rendering of the first subset at the client device; and in response to receiving the user input indicating the user selection of the modified response, identifying a personalization signal based on the modified response.

In some implementations, determining the at least three responses to the first NL based input includes identifying respective confidence measures for the at least three responses to the first NL based input. In some implementations, the respective confidence measures for the at least three responses to the first NL based input are used in determining the respective scores of the at least three responses to the first NL based input. In some implementations, the respective confidence measures for the at least two responses in the first subset are rendered at the client device. In some implementations, causing each of the at least two responses in the first subset to be rendered at the client device includes causing indications of respective characteristics associated with the at least two responses in the first subset to be rendered at the client device.

In some additional or alternative implementations, a computer program product may include one or more computer-readable storage media having program instructions collectively stored on the one or more computer-readable storage media. The program instructions may be executable to: receive first natural language (NL) based input associated with a client device; generate, based on the first NL based input and using at least one large language model (LLM), one or more instances of first LLM output; determine, based on the one or more instances of first LLM output, at least three responses to the first NL based input; determine, based on at least one scoring criterion, respective scores of the at least three responses to the first NL based input; select, based on the respective scores of the at least three responses to the first NL based input, from the at least three responses to the first NL based input, a first subset, the first subset including at least two responses to the first NL based input; and cause each of the at least two responses in the first subset to be rendered at the client device.

In some additional or alternative implementations, a system may include a processor, a computer-readable memory, one or more computer-readable storage media, and program instructions collectively stored on the one or more computer-readable storage media. The program instructions may be executable to: receive first natural language (NL) based input associated with a client device; generate, based on the first NL based input and using at least one large language model (LLM), one or more instances of first LLM output; determine, based on the one or more instances of first LLM output, at least three responses to the first NL based input; determine, based on at least one scoring criterion, respective scores of the at least three responses to the first NL based input; select, based on the respective scores of the at least three responses to the first NL based input, from the at least three responses to the first NL based input, a first subset, the first subset including at least two responses to the first NL based input; and cause each of the at least two responses in the first subset to be rendered at the client device.

The above description is provided as an overview of some implementations of the present disclosure. Further description of those implementations, and other implementations, are described in more detail below.

Various implementations can include a non-transitory computer readable storage medium storing instructions executable by one or more processors (e.g., central processing unit(s) (CPU(s)), graphics processing unit(s) (GPU(s)), digital signal processor(s) (DSP(s)), and/or tensor processing unit(s) (TPU(s)) to perform a method such as one or more of the methods described herein. Other implementations can include a client device that includes processor(s) operable to execute stored instructions to perform a method, such as one or more of the methods described herein. Yet other implementations can include a system of one or more servers that include one or more processors operable to execute stored instructions to perform a method such as one or more of the methods described herein.

### BRIEF DESCRIPTION OF THE DRAWINGS

FIG. 1 depicts a block diagram of an example environment that demonstrates various aspects of the present disclosure, and in which some implementations disclosed herein can be implemented.

FIGS. 2, 3, 4, 5, 6, 7, 8, and 9 depict flowcharts illustrating example methods for personalized multi-response dialog generated using a large language model, in accordance with various implementations.

FIG. 10 and FIG. 11 depict various non-limiting examples of personalized multi-response dialog generated using one or more large language models, in accordance with various implementations.

FIG. 12 depicts an example architecture of a computing device, in accordance with various implementations.

### DETAILED DESCRIPTION OF THE DRAWINGS

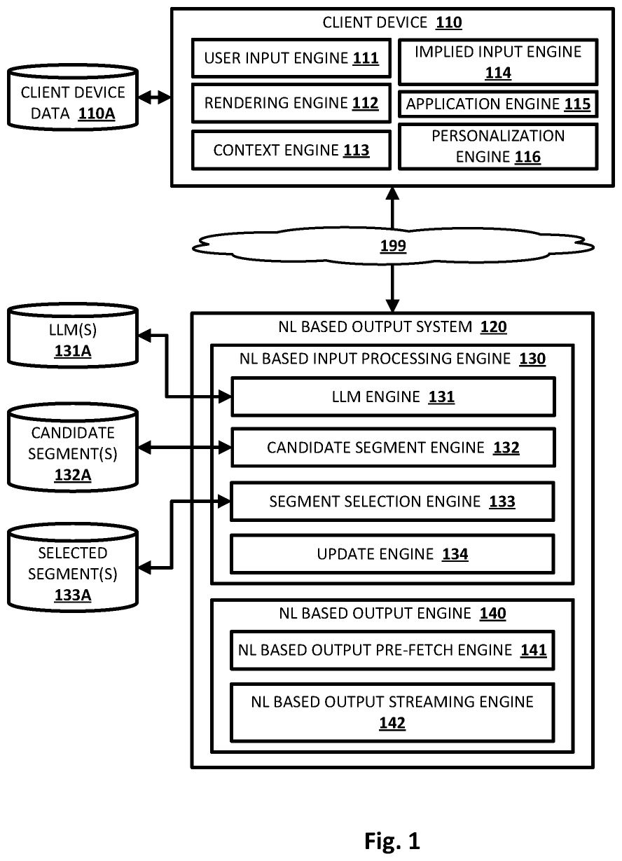

Turning now to FIG. 1, a block diagram of an example environment that demonstrates various aspects of the present disclosure, and in which implementations disclosed herein can be implemented, is depicted. Any computing devices depicted in FIG. 1 or elsewhere in the figures may include logic such as one or more microprocessors (e.g., central processing units or “CPUs”, graphical processing units or “GPUs”) that execute computer-readable instructions stored in memory, or other types of logic such as application-specific integrated circuits (“ASIC”), field-programmable gate arrays (“FPGA”), and so forth. Some of the systems depicted in FIG. 1, such as NL based output system 120, may be implemented using one or more server computing devices that form what is sometimes referred to as a “cloud infrastructure,” although this is not required.

The example environment includes a client device 110 and a natural language (NL) based output system 120. In some implementations, all or aspects of the NL based output system 120 can be implemented locally at the client device 110. In additional or alternative implementations, all or aspects of the NL based output system 120 can be implemented remotely from the client device 110 as depicted in FIG. 1 (e.g., at remote server(s)). In those implementations, the client device 110 and the NL based output system 120 can be communicatively coupled with each other via one or more networks 199, such as one or more wired or wireless local area networks (“LANs,” including Wi-Fi, mesh networks, Bluetooth, near-field communication, etc.) or wide area networks (“WANs”, including the Internet).

The client device 110 can be, for example, one or more of: a desktop computer, a laptop computer, a tablet, a mobile phone, a computing device of a vehicle (e.g., an in-vehicle communications system, an in-vehicle entertainment system, an in-vehicle navigation system), a standalone interactive speaker (optionally having a display), a smart appliance such as a smart television, and/or a wearable apparatus of the user that includes a computing device (e.g., a watch of the user having a computing device, glasses of the user having a computing device, a virtual or augmented reality computing device). Additional and/or alternative client devices may be provided.

The client device 110 can execute one or more software applications, via application engine 115, through which NL based input can be submitted and/or NL based output and/or other output to the NL based input can be rendered (e.g., audibly and/or visually). The application engine 115 can execute one or more software applications that are separate from an operating system of the client device 110 (e.g., one installed “on top” of the operating system)—or can alternatively be implemented directly by the operating system of the client device 110. For example, the application engine 115 can execute a web browser installed on top of the operating system of the client device 110, or the web browser can be a software application that is integrated as part of the operating system of the client device 110. The application engine 115 (and the one or more software applications executed by the application engine 115) can interact with the NL based output system 120.

In various implementations, the client device 110 can include a user input engine 111 that is configured to detect user input provided by a user of the client device 110 using one or more user interface input devices. For example, the client device 110 can be equipped with one or more microphones that capture audio data, such as audio data corresponding to spoken utterances of the user or other sounds in an environment of the client device 110. Additionally, or alternatively, the client device 110 can be equipped with one or more vision components that are configured to capture vision data corresponding to images and/or movements (e.g., gestures) detected in a field of view of one or more of the vision components. Additionally, or alternatively, the client device 110 can be equipped with one or more touch sensitive components (e.g., a keyboard and mouse, a stylus, a touch screen, a touch panel, one or more hardware buttons, etc.) that are configured to capture signal(s) corresponding to touch input directed to the client device 110.

Some instances of a NL based input described herein can be a query for a NL response that is formulated based on user input provided by a user of the client device 110 and detected via user input engine 111. For example, the query can be a typed query that is typed via a physical or virtual keyboard, a suggested query that is selected via a touch screen or a mouse of the client device 110, a spoken voice query that is detected via microphone(s) of the client device 110 (and optionally directed to an automated assistant executing at least in part at the client device 110), or an image or video query that is based on vision data captured by vision component(s) of the client device 110 (or based on NL input generated base on processing the image using, for example, object detection model(s), captioning model(s), etc.). Other instances of a NL based input described herein can be a prompt for NL content that is formulated based on user input provided by a user of the client device 110 and detected via the user input engine 111. For example, the prompt can be a typed prompt that is typed via a physical or virtual keyboard, a suggested prompt that is selected via a touch screen or a mouse of the client device 110, a spoken prompt that is detected via microphone(s) of the client device 110, or an image prompt that is based on an image captured by a vision component of the client device 110.

In various implementations, the client device 110 can include a rendering engine 112 that is configured to provide content (e.g., NL based output, an indication of source(s) associated with the NL based output, and/or other content) for audible and/or visual presentation to a user of the client device 110 using one or more user interface output devices. For example, the client device 110 can be equipped with one or more speakers that enable the content to be provided for audible presentation to the user via the client device 110. Additionally, or alternatively, the client device 110 can be equipped with a display or projector that enables the content to be provided for visual presentation to the user via the client device 110.

In various implementations, the client device 110 can include a context engine 113 that is configured to determine a context (e.g., current or recent context) of the client device 110 and/or of a user of the client device 110 (e.g., an active user of the client device 110 when the client device 110 is associated with multiple users). In some of those implementations, the context engine 113 can determine a context based on data stored in client device data database 110A. The data stored in the client device data database 110A can include, for example, user interaction data that characterizes current or recent interaction(s) of the client device 110 and/or a user of the client device 110, location data that characterizes a current or recent location(s) of the client device 110 and/or a user of the client device 110, user attribute data that characterizes one or more attributes of a user of the client device 110, user preference data that characterizes one or more preferences of a user of the client device 110, user profile data that characterizes a profile of a user of the client device 110, and/or any other data accessible to the context engine 113 via the client device data database 110A or otherwise.

For example, the context engine 113 can determine a current context based on a current state of a dialog session (e.g., considering one or more recent inputs provided by a user during the dialog session), profile data, and/or a current location of the client device 110. For instance, the context engine 113 can determine a current context of “visitor looking for upcoming events in Louisville, Kentucky” based on a recently issued query, profile data, and an anticipated future location of the client device 110 (e.g., based on recently booked hotel accommodations). As another example, the context engine 113 can determine a current context based on which software application is active in the foreground of the client device 110, a current or recent state of the active software application, and/or content currently or recently rendered by the active software application. A context determined by the context engine 113 can be utilized, for example, in supplementing or rewriting NL based input that is formulated based on user input, in generating an implied NL based input (e.g., an implied query or prompt formulated independent of any explicit NL based input provided by a user of the client device 110), and/or in determining to submit an implied NL based input and/or to render result(s) (e.g., an NL based output) for an implied NL based input.

In various implementations, the client device 110 can include a personalization engine 116 that is configured to identify a personalization signal based on user selections of particular responses to NL based input. The personalization signal may be associated with a particular user account (e.g., a user account associated with an active user of the client device 110 when the client device 110 is associated with multiple users). In some of those implementations, the personalization engine 113 can store personalization data in client device data database 110A. The personalization data stored in the client device data database 110A can include, for example, one or more personalization signals, and/or a personalization model based on one or more personalization signals identified by the personalization engine 116.

In other implementations, the personalization engine 116 or components thereof may be included in the NL based output system 120, instead of or in addition to being included in the client device 110. Additionally, personalization data (e.g., one or more personalization signals, and/or a personalization model based on one or more personalization signals identified by the personalization engine 116) may be stored in one or more databases accessible to the NL based output system 120, instead of or in addition to being stored in the client device data database 110A.

In some implementations, one or more personalization signals may be used by the client device 110 and/or by the NL based output system 120 to shape responses in a current dialog session but may not persist to subsequent dialog sessions. In other implementations, one or more personalization signals may persist across subsequent dialog sessions, but the impact on responses may diminish over time. In still other implementations, a degree of persistence or “stickiness” of a personalization signal may depend on whether or not subsequent responses selected by the user reinforce the signal (e.g., whether or not the same personalization signal is detected in multiple responses selected by the user).

For example, a “sarcastic” personalization signal may be identified based on multiple past selections of sarcastic responses. Nonetheless, a “serious” response may still be provided as one of multiple responses at least selectively (e.g., in the case of a topic identified as a “serious” topic, and despite a user's “sarcastic” preference, a score/ranking of a “serious” response may be high). Continuing with the example, if the user selects the “serious” response, the personalization engine 116 may use that selection to heavily influence future responses in the current session. However, the selection may only minimally impact (or not at all) longer-term responses.

In various implementations, the client device 110 can include an implied input engine 114 that is configured to: generate an implied NL based input independent of any user explicit NL based input provided by a user of the client device 110; submit an implied NL based input, optionally independent of any user explicit NL based input that requests submission of the implied NL based input; and/or cause rendering of search result(s) or a NL based output for the implied NL based input, optionally independent of any explicit NL based input that requests rendering of the search result(s) or the NL based output. For example, the implied input engine 114 can use one or more past or current contexts, from the context engine 113, in generating an implied NL based input, determining to submit the implied NL based input, and/or in determining to cause rendering of search result(s) or a NL based output that is responsive to the implied NL based input. For instance, the implied input engine 114 can automatically generate and automatically submit an implied query or implied prompt based on the one or more past or current contexts. Further, the implied input engine 114 can automatically push the search result(s) or the NL based output that is generated responsive to the implied query or implied prompt to cause them to be automatically rendered or can automatically push a notification of the search result(s) or the NL based output, such as a selectable notification that, when selected, causes rendering of the search result(s) or the NL based output. Additionally, or alternatively, the implied input engine 114 can submit respective implied NL based input at regular or non-regular intervals, and cause respective search result(s) or respective NL based outputs to be automatically provided (or a notification thereof automatically provided). For instance, the implied NL based input can be “patent news” based on the one or more past or current contexts indicating a user's general interest in patents, the implied NL based input or a variation thereof periodically submitted, and the respective search result(s) or the respective NL based outputs can be automatically provided (or a notification thereof automatically provided). It is noted that the respective search result(s) or the respective NL based output can vary over time in view of, e.g., presence of new/fresh search result document(s) over time.

Further, the client device 110 and/or the NL based output system 120 can include one or more memories for storage of data and/or software applications, one or more processors for accessing data and executing the software applications, and/or other components that facilitate communication over one or more of the networks 199. In some implementations, one or more of the software applications can be installed locally at the client device 110, whereas in other implementations one or more of the software applications can be hosted remotely (e.g., by one or more servers) and can be accessible by the client device 110 over one or more of the networks 199.

Although aspects of FIG. 1 are illustrated or described with respect to a single client device having a single user, it should be understood that is for the sake of example and is not meant to be limiting. For example, one or more additional client devices of a user and/or of additional user(s) can also implement the techniques described herein. For instance, the client device 110, the one or more additional client devices, and/or any other computing devices of a user can form an ecosystem of devices that can employ techniques described herein. These additional client devices and/or computing devices may be in communication with the client device 110 (e.g., over the network(s) 199). As another example, a given client device can be utilized by multiple users in a shared setting (e.g., a group of users, a household, a workplace, a hotel, etc.).

The NL based output system 120 is illustrated in FIG. 1 as including a NL based input processing engine 130 and a NL based output engine 140. Some of these engines can be combined and/or omitted in various implementations. Further, these engines can include various sub-engines. For instance, the NL based input processing engine 130 is illustrated in FIG. 1 as including a LLM engine 131, a candidate segment engine 132, a segment selection engine 133, and an update engine 134. Further, the NL based output engine 140 is illustrated in FIG. 1 as including a NL based output pre-fetch engine 141 and a NL based output streaming engine 142. Similarly, some of these sub-engines can be combined and/or omitted in various implementations. For instance, the NL based output pre-fetch engine 141 and the NL based output streaming engine 142 can be combined, the LLM engine 131 and the candidate segment engine 132 can be combined, the LLM engine 131 and the update engine 134 can be combined. Accordingly, it should be understood that the various engines and sub-engines of the NL based output system 120 illustrated in FIG. 1 are depicted for the sake of describing certain functionalities and is not meant to be limiting.

Further, the NL based output system 120 is illustrated in FIG. 1 as interfacing with various databases, such as a LLM database 131A, candidate segment(s) database 132A, and a selected segment(s) database 133A. Although particular engines and/or sub-engines are depicted as having access to particular databases, it should be understood that is for the sake of example and is not meant to be limiting. For instance, in some implementations, each of the various engines and/or sub-engines of the NL based output system 120 may have access to each of the various databases.

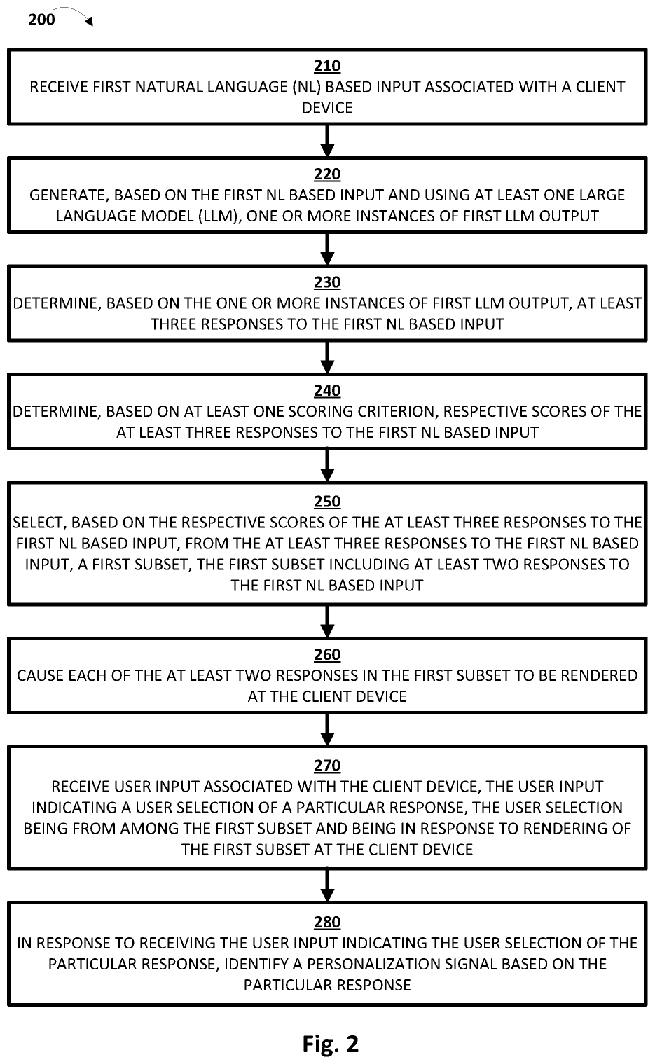

As described in more detail herein (e.g., with respect to FIG. 2), the NL based output system 120 can be utilized to generate a stream of NL based output that is responsive to NL based input and based on processing the NL based input using LLM(s). The stream of NL based output can include a plurality of segments and can be generated on a segment-by-segment basis. Additional description of the various engines and/or sub-engines of the NL based output system 120 is provided herein with respect to FIG. 2.

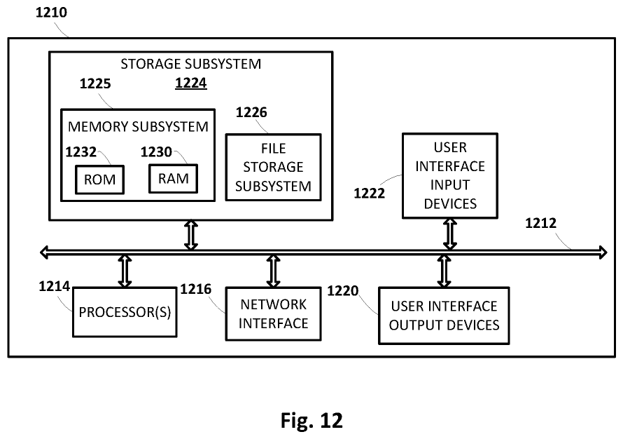

Turning now to FIG. 2, a flowchart illustrating an example method 200 for personalized multi-response dialog generated using a large language model is depicted. For convenience, the operations of the method 200 are described with reference to a system that performs the operations. This system of method 200 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 200 are shown in a particular order, this is not meant to be limiting. One or more operations may be reordered, omitted, and/or added.

At block 210, the system receives first natural language (NL) based input associated with a client device. In some implementations, the first NL based input can be one formulated based on explicit user interface input at a client device (e.g., detected via the user input engine 111), such as typed input, voice input, input to cause an image to be captured or selected, etc. In some of those implementations, the first NL based input can be a query. The query can be, for example, a voice query, a typed query, an image-based query, or a multimodal query (e.g., that includes voice input, and an image or video). In some implementations, when the query includes content that is not in textual format, the system can convert the query to a textual format or other format. For example, if the query is a voice query, then the system can perform automatic speech recognition (ASR) to convert the query to textual format. As another example, if the query is a multimodal query that includes an image or video of an avocado and a voice input of “is this healthy”, then the system can perform ASR to convert the voice input to text form and can perform image or video processing on the image or video to recognize an avocado is present in the image or video, and can perform co-reference resolution to replace “this” with “an avocado”, resulting in a textual format query of “is an avocado healthy”.

In some implementations, the first NL based input can be received in an application environment of one or more software applications that are accessible at the client device, such as a browser software application, an automated assistant software application, etc. (e.g., via the application engine 115). In additional or alternative versions of those implementations, the system can augment the first NL based input (e.g., augment the explicit NL based input) with additional information, such as one or more past or current contexts of the client device and/or a user of the client device (e.g., via the context engine 113).

In other implementations, the first NL based input can alternatively be implied NL based input, such as an inferred/parameterless query, such as one formulated and/or submitted independent of any explicit user NL based input directed to formulating the implied NL based input (e.g., as described with respect to the context engine 113 and/or the implied input engine 114 of FIG. 1). For example, the query can be an implied query that is automatically generated based on profile data and that is automatically submitted. For instance, the implied NL based input can be an implied query of “machine learning”, based on profile data indicating interest in machine learning topic(s). As another example, the implied NL based input can be an implied query that is automatically generated and/or automatically submitted based on a current and/or recent context. As yet another example, the implied NL based input can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 220, the system generates, based on the first NL based input and using at least one large language model (LLM), one or more instances of first LLM output. For example, the system can cause the LLM engine 131 to process, using at least one LLM stored in the LLM(s) database 131A, the first NL based input to generate one or more instances of first LLM output. The at least one LLM can include, for example, any LLM that is stored in the LLM(s) database 131A, such as PaLM, BERT, LaMDA, Meena, GPT-3, GPT-4, ChatGPT, and/or any other LLM. In other implementations, one or more of the at least one LLM may be a specially-tuned LLM, such as a search-result tuned LLM that is tuned based on a search result index and, an advertising-tuned LLM that is tuned based on advertising content, and/or any other specially-tuned LLM. Further, the one or more instances of first LLM output can include, for example, a probability distribution over a sequence of words or phrases that are predicted to be responsive to the first NL based input. Notably, each of the at least one LLM can include billions of weights and/or parameters that are learned through training the LLM on enormous amounts of diverse data. This enables the LLM to generate the one or more instances of the first LLM output as the probability distribution over the sequence of words or phrases. In some implementations, the sequence of words or phrases corresponds to a vocabulary. In some versions of these implementations, the vocabulary can optionally be restricted to that of a particular persona or a particular domain. This enables the LLM to reflect the particular persona or appear well-versed in the particular domain. In some implementations, the one or more instances of first LLM output can be considered a stream in that, as each word or phrase of the first NL based input is being processed using the LLM, the probability distribution over the sequence of words or phrases that are predicted to be responsive to the first NL based input can be continuously updated and with respect any previously selected segments for a stream of NL based output.

In some implementations, generating the one or more instances of first LLM output may include providing the first NL based input to a third party, e.g., using an application programming interface (API) call or web service request, for processing by the third party, using at least one LLM maintained by the third party. Responsive to providing the first NL based input, the third party may return the one or more instances of first LLM output, e.g., as a response to the API call or web service request.

At block 230, the system determines, based on the one or more instances of first LLM output, at least three responses to the first NL based input. For example, the system can cause the candidate segment engine 132 to determine, based on the probability distribution over the sequence of words or phrases, the at least three responses to the first NL based input. The candidate segment engine 132 can utilize matrix multiplication using the weights and/or parameters of the LLM to determine the at least three responses to the first NL based input. In some implementations, the at least three responses to the first NL based input can include a fixed number of responses. For instance, the fixed number of responses can include the three most likely responses including words or phrases that are predicted to be responsive to the first NL based input and based on the probability distribution for the words or phrases, the 10 most likely responses including words or phrases that are predicted to be responsive to the first NL based input and based on the probability distribution for the words or phrases, the 16 most likely responses including words or phrases that are predicted to be responsive to the first NL based input and based on the probability distribution for the words or phrases, and/or any other fixed number of responses. In other implementations, any number of responses corresponding to words or phrases that are associated with one or more probabilities from the probability distribution over the sequence of words or phrases that satisfy a threshold probability may be determined. In some implementations, the candidate segment engine 132 can store the candidate segments as they are determined in the candidate segment(s) database 132A.

In some implementations, at block 220, generating the one or more instances of first LLM output may include: processing the first NL based input, using a first LLM, to generate a first instance of the one or more instances of first LLM output; and processing the first NL based input, using a second LLM, to generate a second instance of the one or more instances of first LLM output. In these implementations, at block 230, determining the at least three responses to the first NL based input may include: determining, based on the first instance, a first response to the first NL based input; and determining, based on the second instance, a second response to the first NL based input.

In other implementations, at block 220, generating the one or more instances of first LLM output may include processing the first NL based input, using a first LLM, to generate a first instance of the one or more instances of first LLM output. In these implementations, at block 230, determining the at least three responses to the first NL based input may include: determining, based on the first instance, a first response to the first NL based input; determining, based on the first instance, a second response to the first NL based input; and determining, based on the first instance, a third response to the first NL based input.

In still other implementations, at block 220, generating the one or more instances of first LLM output may include: processing the first NL based input, using a first LLM, to generate a first instance of the one or more instances of first LLM output; modifying the first NL based input to generate modified NL based input; and processing the modified NL based input, using the first LLM, to generate a second instance of the one or more instances of first LLM output. In these implementations, at block 230, determining the at least three responses to the first NL based input may include: determining, based on the first instance, a first response to the first NL based input; and determining, based on the second instance, a second response to the first NL based input. In some implementations, modifying the first NL based input to generate the modified NL based input includes modifying the first NL based input to bias towards at least one response characteristic. In some implementations, the at least one response characteristic includes a tone (e.g., serious, sarcastic, silly, formal, informal, etc.) of a response. In some implementations, the at least one response characteristic includes a length of a response (e.g., 2-3 sentences, a longer paragraph, multiple paragraphs, etc.). In some implementations, the at least one response characteristic includes a complexity of a response (e.g., fourth grade reading level, college reading level, assuming no knowledge of topic, assuming expert-level knowledge of topic, etc.).

In some implementations, determining the at least three responses to the first NL based input includes identifying respective confidence measures for the at least three responses to the first NL based input. The respective confidence measures for the at least three responses to the first NL based input may be used in determining the respective scores of the at least three responses to the first NL based input. In some implementations, the respective confidence measures for the at least two responses in the first subset are rendered at the client device. In some implementations, causing each of the at least two responses in the first subset to be rendered at the client device includes causing indications of respective characteristics associated with the at least two responses in the first subset to be rendered at the client device.

At block 240, the system determines, based on at least one scoring criterion, respective scores of the at least three responses to the first NL based input. For example, the system can cause the segment selection engine 133 to determine, based on at least one scoring criterion, respective scores of the at least three responses to the first NL based input. In various implementations, the one or more scoring criterion may include an assurance criterion, an accuracy criterion, a quality criterion, and/or any other criteria. The assurance criterion can, for example, reflect a level of assurance or safety associated with each of the at least three responses. Put another way, the assurance criterion for each of the at least three responses can reflect a corresponding level of assurance for a user of the client device from which the first NL based input was received if the corresponding response was subsequently rendered at the client device. Further the accuracy criterion can, for example, reflect a level of accuracy or trustworthiness associated with each of the at least three responses in instances where the responses include factual information. Moreover, the quality criterion can, for example, reflect a corresponding quality score associated with each of the at least three responses. Although particular scoring criteria are described herein, it should be understood that these scoring criteria are provided for the sake of example and that any other suitable scoring criteria can be utilized.

In some implementations, the at least one scoring criterion includes a diversity measure that is based on a level of distinctiveness relative to other ones of the at least three responses to the first NL based input.

At block 250, the system selects, based on the respective scores of the at least three responses to the first NL based input, from the at least three responses to the first NL based input, a first subset, the first subset including at least two responses to the first NL based input. For example, the system can cause the segment selection engine 133 to select, based on the respective scores of the at least three responses to the first NL based input, a first subset, the first subset including at least two responses to the first NL based input. In some implementations, each response having a score satisfying a threshold may be included in the first subset. In other implementations, a number of highest-scoring responses may be included in the first subset. The number may be a predetermined number, a user-configurable number, or a dynamically determined number. The system can optionally store the responses in the first subset in one or more databases (e.g., the selected segment(s) database 133A).

At block 260, the system causes each of the at least two responses in the first subset to be rendered at the client device. In some implementations, the NL based output engine 140 may cause each of the at least two responses in the first subset to be transmitted to client device 110, and the rendering engine 112 may cause each of the at least two responses in the first subset to be rendered on the display 180.

For example, textual data corresponding to each of the at least two responses in the first subset can be transmitted to the client device for visual rendering via the display of the client device. In some versions of those implementations, the NL based output streaming engine 142 may cause the textual data corresponding to each of the at least two responses in the first subset to be rendered in a streaming manner, such as a on word-by-word basis, a segment-by-segment basis, and/or or in other streaming manners. In additional or alternative implementations, each of the at least two responses in the first subset can be audibly rendered via speaker(s) of the client device (e.g., via the rendering engine 112). In some versions of these implementations, textual data corresponding to the NL based output can be transmitted to the client device and the client device can process, using text-to-speech model(s), synthesized speech audio data to generate synthesized speech capturing the textual data corresponding to the stream of NL based output. The synthesized audio data can be audibly rendered via the speaker(s) of the client device. In other versions of those implementations, the synthesized speech audio data can be generated remotely from the client device (e.g., at a remote server in implementations where the system is hosted at the remote server), and the synthesized speech audio data can be transmitted to the client device and audibly rendered via the speaker(s) of the client device.

At block 270, the system receives user input associated with the client device, the user input indicating a user selection of a particular response, the user selection being from among the first subset and being in response to rendering of the first subset at the client device. In some implementations, the user input indicating the user selection of the particular response may be received in an application environment of one or more software applications that are accessible at the client device, such as a browser software application, an automated assistant software application, etc. (e.g., via the application engine 115) and may be detected via the user input engine 111. In some implementations, the user input may be a click, a tap, typed input, voice input, etc.

In some implementations, instead of receiving the user input indicating a user selection of a particular response at block 270, the system receives user input associated with the client device, the user input indicating a user selection of a modified response, the modified response selected by the user being a version of a response in the first subset that has been modified by the user, and the user selection being in response to rendering of the first subset at the client device.

At block 280, in response to receiving the user input indicating the user selection of the particular response, the system identifies a personalization signal based on the particular response. In some implementations, in response to receiving the user input indicating the user selection of the particular response, the personalization engine 116 may identify a personalization signal. In some implementations, the personalization signal may be based on one or more distinguishing characteristics associated with the particular response. The personalization engine 116 may use this personalization signal to build and/or train a personalization model associated with a user of the client device 110. This personalization model may be stored in the client device data 110A and may be used, e.g., in generating responses to subsequent NL based input.

In some implementations, at block 280, the system can optionally store the particular response in one or more databases (e.g., the selected segment(s) database 133A). For example, the system can cause the update engine 134 to update the state of the LLM based on the particular response that was selected at block 270.

In some implementations, when the system receives the user input indicating a user selection of a modified response at block 270, instead of receiving the user input indicating a user selection of a particular response at block 270, at block 280, the system identifies a personalization signal based on the modified response, in response to receiving the user input indicating the user selection of the modified response.

In other implementations, at block 230 of FIG. 2, at least two responses to the first NL based input are determined, and at block 240, respective scores are determined for the at least two responses. At block 250, each of the at least two responses to the first NL based input may be selected and may be ordered based on the scores. At block 260, each of the at least two responses may be rendered at the client device, in the order determined at block 250 based on the scores.

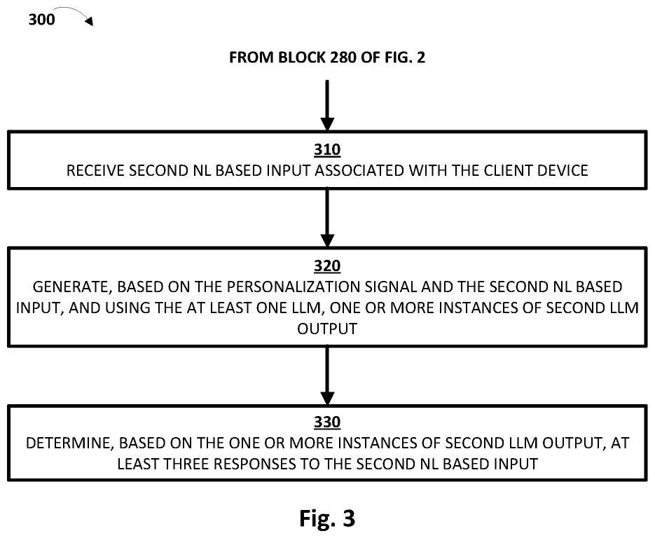

Turning now to FIG. 3, a flowchart illustrating an example method 300 for personalized multi-response dialog generated using a large language model is depicted. For convenience, the operations of the method 300 are described with reference to a system that performs the operations. This system of method 300 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 300 are shown in a particular order, this is not meant to be limiting. One or more operations may be reordered, omitted, and/or added.

In some implementations, after performing the operations at block 280 of FIG. 2, the flow may proceed to block 310 of FIG. 3. At block 310, the system receives second NL based input associated with the client device.

In some implementations, the second NL based input can be one formulated based on explicit user interface input at a client device (e.g., detected via the user input engine 111), such as typed input, voice input, input to cause an image to be captured or selected, etc. In some of those implementations, the second NL based input can be a query. The query can be, for example, a voice query, a typed query, an image-based query, or a multimodal query (e.g., that includes voice input, and an image or video). In some implementations, when the query includes content that is not in textual format, the system can convert the query to a textual format or other format. For example, if the query is a voice query, then the system can perform automatic speech recognition (ASR) to convert the query to textual format. As another example, if the query is a multimodal query that includes an image or video of an avocado and a voice input of “is this healthy”, then the system can perform ASR to convert the voice input to text form and can perform image or video processing on the image or video to recognize an avocado is present in the image or video, and can perform co-reference resolution to replace “this” with “an avocado”, resulting in a textual format query of “is an avocado healthy”.

In some implementations, the second NL based input can be received in an application environment of one or more software applications that are accessible at the client device, such as a browser software application, an automated assistant software application, etc. (e.g., via the application engine 115). In additional or alternative versions of those implementations, the system can augment the second NL based input (e.g., augment the explicit NL based input) with additional information, such as one or more past or current contexts of the client device and/or a user of the client device (e.g., via the context engine 113).

In other implementations, the second NL based input can alternatively be implied NL based input, such as an inferred/parameterless query, such as one formulated and/or submitted independent of any explicit user NL based input directed to formulating the implied NL based input (e.g., as described with respect to the context engine 113 and/or the implied input engine 114 of FIG. 1). For example, the query can be an implied query that is automatically generated based on profile data and that is automatically submitted. For instance, the implied NL based input can be an implied query of “machine learning”, based on profile data indicating interest in machine learning topic(s). As another example, the implied NL based input can be an implied query that is automatically generated and/or automatically submitted based on a current and/or recent context. As yet another example, the implied NL based input can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 320, the system generates, based on the personalization signal and the second NL based input, and using the at least one LLM, one or more instances of second LLM output. In some implementations, the personalization signal is used, along with the second NL based input, in generating the one or more instances of second LLM output, in response to identifying the personalization signal in response to receiving the user input indicating the user selection of the particular response.

For example, the system can cause the LLM engine 131 to process, using at least one LLM stored in the LLM(s) database 131A, (i) the personalization signal and/or a personalization model, and (ii) the second NL based input, to generate one or more instances of second LLM output. The at least one LLM can include, for example, any LLM that is stored in the LLM(s) database 131A, such as PaLM, BERT, LaMDA, Meena, GPT-3, GPT-4, ChatGPT, and/or any other LLM. In other implementations, one or more of the at least one LLM may be a specially-tuned LLM, such as a search-result tuned LLM that is tuned based on a search result index and, an advertising-tuned LLM that is tuned based on advertising content, and/or any other specially-tuned LLM. Further, the one or more instances of second LLM output can include, for example, a probability distribution over a sequence of words or phrases that are predicted to be responsive to the second NL based input. Notably, each of the at least one LLM can include billions of weights and/or parameters that are learned through training the LLM on enormous amounts of diverse data. This enables the LLM to generate the one or more instances of the second LLM output as the probability distribution over the sequence of words or phrases. In some implementations, the sequence of words or phrases corresponds to a vocabulary. In some versions of these implementations, the vocabulary can optionally be restricted to that of a particular persona or a particular domain. This enables the LLM to reflect the particular persona or appear well-versed in the particular domain. In some implementations, the one or more instances of second LLM output can be considered a stream in that, as each word or phrase of the second NL based input is being processed using the LLM, the probability distribution over the sequence of words or phrases that are predicted to be responsive to the second NL based input can be continuously updated and with respect any previously selected segments for a stream of NL based output.

In some implementations, generating the one or more instances of second LLM output may include providing the second NL based input (and, optionally, the personalization signal) to a third party, e.g., using an application programming interface (API) call or web service request, for processing by the third party, using at least one LLM maintained by the third party. Responsive to providing the second NL based input, the third party may return the one or more instances of second LLM output, e.g., as a response to the API call or web service request.

At block 330, the system determines, based on the one or more instances of second LLM output, at least three responses to the second NL based input. For example, the system can cause the candidate segment engine 132 to determine, based on the probability distribution over the sequence of words or phrases, the at least three responses to the second NL based input. The candidate segment engine 132 can utilize matrix multiplication using the weights and/or parameters of the LLM to determine the at least three responses to the second NL based input. In some implementations, the at least three responses to the second NL based input can include a fixed number of responses. For instance, the fixed number of responses can include the three most likely responses including words or phrases that are predicted to be responsive to the second NL based input and based on the probability distribution for the words or phrases, the 10 most likely responses including words or phrases that are predicted to be responsive to the second NL based input and based on the probability distribution for the words or phrases, the 16 most likely responses including words or phrases that are predicted to be responsive to the second NL based input and based on the probability distribution for the words or phrases, and/or any other fixed number of responses. In other implementations, any number of responses corresponding to words or phrases that are associated with one or more probabilities from the probability distribution over the sequence of words or phrases that satisfy a threshold probability may be determined. In some implementations, the candidate segment engine 132 can store the candidate segments as they are determined in the candidate segment(s) database 132A.

In some implementations, at block 320, generating the one or more instances of second LLM output may include: processing the personalization signal and the second NL based input, using a first LLM, to generate a first instance of the one or more instances of second LLM output; and processing the personalization signal and the second NL based input, using a second LLM, to generate a second instance of the one or more instances of second LLM output. In these implementations, at block 330, determining the at least three responses to the second NL based input may include: determining, based on the first instance, a first response to the second NL based input; and determining, based on the second instance, a second response to the second NL based input.

In other implementations, at block 320, generating the one or more instances of second LLM output may include processing the personalization signal and the second NL based input, using a first LLM, to generate a first instance of the one or more instances of second LLM output. In these implementations, at block 330, determining the at least three responses to the second NL based input may include: determining, based on the first instance, a first response to the second NL based input; determining, based on the first instance, a second response to the second NL based input; and determining, based on the first instance, a third response to the second NL based input.

In still other implementations, at block 320, generating the one or more instances of second LLM output may include: processing the personalization signal and the second NL based input, using a first LLM, to generate a first instance of the one or more instances of second LLM output; modifying the second NL based input to generate modified NL based input; and processing the personalization signal and the modified NL based input, using the first LLM, to generate a second instance of the one or more instances of second LLM output. In these implementations, at block 330, determining the at least three responses to the second NL based input may include: determining, based on the first instance, a first response to the second NL based input; and determining, based on the second instance, a second response to the second NL based input. In some implementations, modifying the second NL based input to generate the modified NL based input includes modifying the second NL based input to bias towards at least one response characteristic. In some implementations, the at least one response characteristic includes a tone (e.g., serious, sarcastic, silly, formal, informal, etc.) of a response. In some implementations, the at least one response characteristic includes a length of a response (e.g., 2-3 sentences, a longer paragraph, multiple paragraphs, etc.). In some implementations, the at least one response characteristic includes a complexity of a response (e.g., fourth grade reading level, college reading level, assuming no knowledge of topic, assuming expert-level knowledge of topic, etc.).

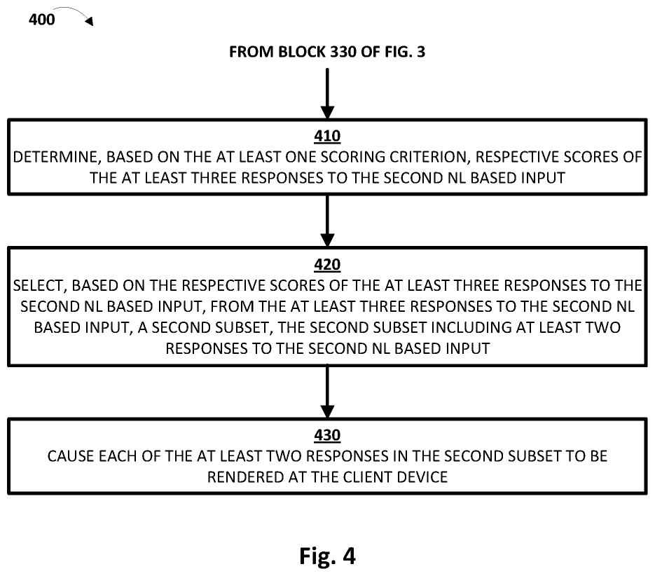

Turning now to FIG. 4, a flowchart illustrating an example method 400 for personalized multi-response dialog generated using a large language model is depicted. For convenience, the operations of the method 400 are described with reference to a system that performs the operations. This system of method 400 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 400 are shown in a particular order, this is not meant to be limiting. One or more operations may be reordered, omitted, and/or added.

In some implementations, after performing the operations at block 330 of FIG. 3, the flow may proceed to block 410 of FIG. 4. At block 410, the system determines, based on the at least one scoring criterion, respective scores of the at least three responses to the second NL based input.

For example, the system can cause the segment selection engine 133 to determine, based on at least one scoring criterion, respective scores of the at least three responses to the second NL based input. In various implementations, the one or more scoring criterion may include an assurance criterion, an accuracy criterion, a quality criterion, and/or any other criteria. The assurance criterion can, for example, reflect a level of assurance or safety associated with each of the at least three responses. Put another way, the assurance criterion for each of the at least three responses can reflect a corresponding level of assurance for a user of the client device from which the second NL based input was received if the corresponding response was subsequently rendered at the client device. Further the accuracy criterion can, for example, reflect a level of accuracy or trustworthiness associated with each of the at least three responses in instances where the responses include factual information. Moreover, the quality criterion can, for example, reflect a corresponding quality score associated with each of the at least three responses. Although particular scoring criteria are described herein, it should be understood that these scoring criteria are provided for the sake of example and that any other suitable scoring criteria can be utilized.

In some implementations, the at least one scoring criterion includes a diversity measure that is based on a level of distinctiveness relative to other ones of the at least three responses to the first NL based input.

At block 420, the system selects, based on the respective scores of the at least three responses to the second NL based input, from the at least three responses to the second NL based input, a second subset, the second subset including at least two responses to the second NL based input. For example, the system can cause the segment selection engine 133 to select, based on the respective scores of the at least three responses to the second NL based input, a second subset, the second subset including at least two responses to the second NL based input. In some implementations, each response having a score satisfying a threshold may be included in the second subset. In other implementations, a number of highest-scoring responses may be included in the second subset. The number may be a predetermined number, a user-configurable number, or a dynamically determined number. The system can optionally store the responses in the second subset in one or more databases (e.g., the selected segment(s) database 133A).

At block 430, the system causes each of the at least two responses in the second subset to be rendered at the client device. In some implementations, the NL based output engine 140 may cause each of the at least two responses in the second subset to be transmitted to client device 110, and the rendering engine 112 may cause each of the at least two responses in the second subset to be rendered on the display 180.

For example, textual data corresponding to each of the at least two responses in the second subset can be transmitted to the client device for visual rendering via the display of the client device. In some versions of those implementations, the NL based output streaming engine 142 may cause the textual data corresponding to each of the at least two responses in the second subset can be rendered in a streaming manner, such as a on word-by-word basis, a segment-by-segment basis, and/or or in other streaming manners. In additional or alternative implementations, each of the at least two responses in the second subset can be audibly rendered via speaker(s) of the client device (e.g., via the rendering engine 112). In some versions of these implementations, textual data corresponding to the NL based output can be transmitted to the client device and the client device can process, using text-to-speech model(s), synthesized speech audio data to generate synthesized speech capturing the textual data corresponding to the stream of NL based output. The synthesized audio data can be audibly rendered via the speaker(s) of the client device. In other versions of those implementations, the synthesized speech audio data can be generated remotely from the client device (e.g., at a remote server in implementations where the system is hosted at the remote server), and the synthesized speech audio data can be transmitted to the client device and audibly rendered via the speaker(s) of the client device.

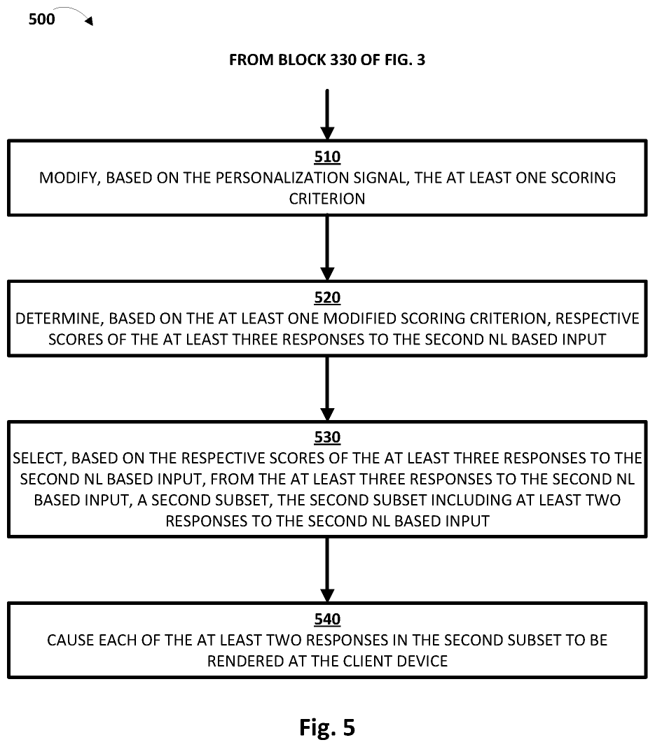

Turning now to FIG. 5, a flowchart illustrating an example method 500 for personalized multi-response dialog generated using a large language model is depicted. For convenience, the operations of the method 500 are described with reference to a system that performs the operations. This system of method 500 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 500 are shown in a particular order, this is not meant to be limiting. One or more operations may be reordered, omitted, and/or added.

In some implementations, after performing the operations at block 330 of FIG. 3, the flow may proceed to block 510 of FIG. 5. At block 510, the system modifies, based on the personalization signal, the at least one scoring criterion.

In various implementations, the at least one scoring criterion may include an assurance criterion, an accuracy criterion, a quality criterion, and/or any other criteria. The assurance criterion can, for example, reflect a level of assurance or safety associated with each of the at least three responses. Put another way, the assurance criterion for each of the at least three responses can reflect a corresponding level of assurance for a user of the client device from which the second NL based input was received if the corresponding response was subsequently rendered at the client device. Further the accuracy criterion can, for example, reflect a level of accuracy or trustworthiness associated with each of the at least three responses in instances where the responses include factual information. Moreover, the quality criterion can, for example, reflect a corresponding quality score associated with each of the at least three responses. Although particular scoring criteria are described herein, it should be understood that these scoring criteria are provided for the sake of example and that any other suitable scoring criteria can be utilized.

At block 520, the system determines, based on the at least one modified scoring criterion, respective scores of the at least three responses to the second NL based input. For example, the system can cause the segment selection engine 133 to determine, based on the at least one modified scoring criterion, respective scores of the at least three responses to the second NL based input.

In some implementations, the at least one scoring criterion includes a diversity measure that is based on a level of distinctiveness relative to other ones of the at least three responses to the second NL based input.

At block 530, the system selects, based on the respective scores of the at least three responses to the second NL based input, from the at least three responses to the second NL based input, a second subset, the second subset including at least two responses to the second NL based input. For example, the system can cause the segment selection engine 133 to select, based on the respective scores of the at least three responses to the second NL based input, a second subset, the second subset including at least two responses to the second NL based input. In some implementations, each response having a score satisfying a threshold may be included in the second subset. In other implementations, a number of highest-scoring responses may be included in the second subset. The number may be a predetermined number, a user-configurable number, or a dynamically determined number. The system can optionally store the responses in the second subset in one or more databases (e.g., the selected segment(s) database 133A).

At block 540, the system causes each of the at least two responses in the second subset to be rendered at the client device. In some implementations, the NL based output engine 140 may cause each of the at least two responses in the second subset to be transmitted to client device 110, and the rendering engine 112 may cause each of the at least two responses in the second subset to be rendered on the display 180.

For example, textual data corresponding to each of the at least two responses in the second subset can be transmitted to the client device for visual rendering via the display of the client device. In some versions of those implementations, the NL based output streaming engine 142 may cause the textual data corresponding to each of the at least two responses in the second subset can be rendered in a streaming manner, such as a on word-by-word basis, a segment-by-segment basis, and/or or in other streaming manners. In additional or alternative implementations, each of the at least two responses in the second subset can be audibly rendered via speaker(s) of the client device (e.g., via the rendering engine 112). In some versions of these implementations, textual data corresponding to the NL based output can be transmitted to the client device and the client device can process, using text-to-speech model(s), synthesized speech audio data to generate synthesized speech capturing the textual data corresponding to the stream of NL based output. The synthesized audio data can be audibly rendered via the speaker(s) of the client device. In other versions of those implementations, the synthesized speech audio data can be generated remotely from the client device (e.g., at a remote server in implementations where the system is hosted at the remote server), and the synthesized speech audio data can be transmitted to the client device and audibly rendered via the speaker(s) of the client device.

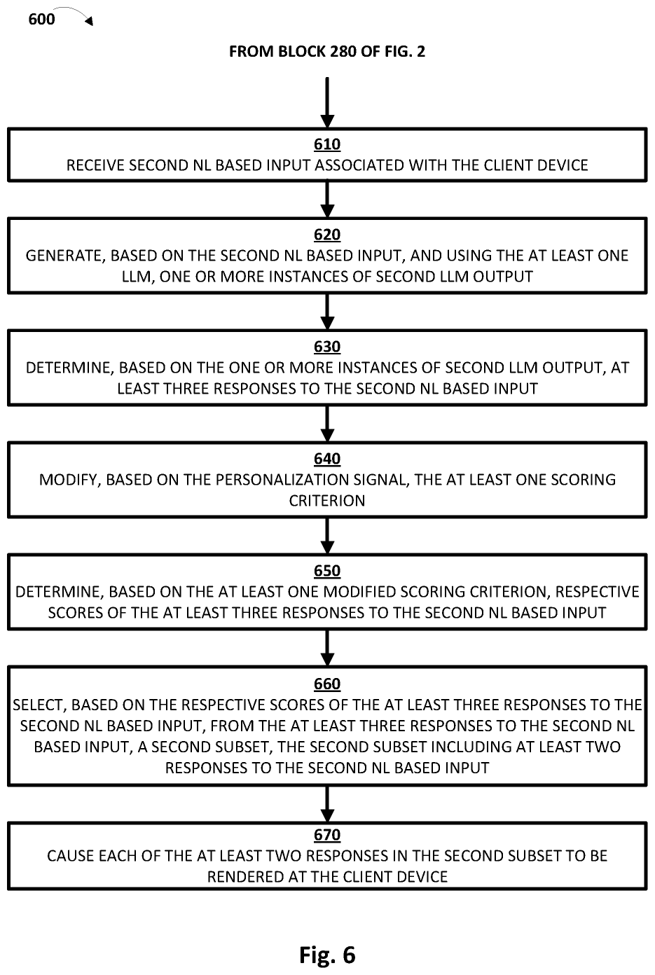

Turning now to FIG. 6, a flowchart illustrating an example method 600 for personalized multi-response dialog generated using a large language model is depicted. For convenience, the operations of the method 600 are described with reference to a system that performs the operations. This system of method 600 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 600 are shown in a particular order, this is not meant to be limiting. One or more operations may be reordered, omitted, and/or added.

In some implementations, after performing the operations at block 280 of FIG. 2, the flow may proceed to block 610 of FIG. 6. At block 610, the system receives second NL based input associated with the client device.

In some implementations, the second NL based input can be one formulated based on explicit user interface input at a client device (e.g., detected via the user input engine 111), such as typed input, voice input, input to cause an image to be captured or selected, etc. In some of those implementations, the second NL based input can be a query. The query can be, for example, a voice query, a typed query, an image-based query, or a multimodal query (e.g., that includes voice input, and an image or video). In some implementations, when the query includes content that is not in textual format, the system can convert the query to a textual format or other format. For example, if the query is a voice query, then the system can perform automatic speech recognition (ASR) to convert the query to textual format. As another example, if the query is a multimodal query that includes an image or video of an avocado and a voice input of “is this healthy”, then the system can perform ASR to convert the voice input to text form and can perform image or video processing on the image or video to recognize an avocado is present in the image or video, and can perform co-reference resolution to replace “this” with “an avocado”, resulting in a textual format query of “is an avocado healthy”.

In some implementations, the second NL based input can be received in an application environment of one or more software applications that are accessible at the client device, such as a browser software application, an automated assistant software application, etc. (e.g., via the application engine 115). In additional or alternative versions of those implementations, the system can augment the second NL based input (e.g., augment the explicit NL based input) with additional information, such as one or more past or current contexts of the client device and/or a user of the client device (e.g., via the context engine 113).

In other implementations, the second NL based input can alternatively be implied NL based input, such as an inferred/parameterless query, such as one formulated and/or submitted independent of any explicit user NL based input directed to formulating the implied NL based input (e.g., as described with respect to the context engine 113 and/or the implied input engine 114 of FIG. 1). For example, the query can be an implied query that is automatically generated based on profile data and that is automatically submitted. For instance, the implied NL based input can be an implied query of “machine learning”, based on profile data indicating interest in machine learning topic(s). As another example, the implied NL based input can be an implied query that is automatically generated and/or automatically submitted based on a current and/or recent context. As yet another example, the implied NL based input can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 620, the system generates, based on the second NL based input, and using the at least one LLM, one or more instances of second LLM output. For example, the system can cause the LLM engine 131 to process, using at least one LLM stored in the LLM(s) database 131A, the second NL based input to generate one or more instances of second LLM output. The at least one LLM can include, for example, any LLM that is stored in the LLM(s) database 131A, such as PaLM, BERT, LaMDA, Meena, GPT-3, GPT-4, ChatGPT, and/or any other LLM. In other implementations, one or more of the at least one LLM may be a specially-tuned LLM, such as a search-result tuned LLM that is tuned based on a search result index and, an advertising-tuned LLM that is tuned based on advertising content, and/or any other specially-tuned LLM. Further, the one or more instances of second LLM output can include, for example, a probability distribution over a sequence of words or phrases that are predicted to be responsive to the second NL based input. Notably, each of the at least one LLM can include billions of weights and/or parameters that are learned through training the LLM on enormous amounts of diverse data. This enables the LLM to generate the one or more instances of the second LLM output as the probability distribution over the sequence of words or phrases. In some implementations, the sequence of words or phrases corresponds to a vocabulary. In some versions of these implementations, the vocabulary can optionally be restricted to that of a particular persona or a particular domain. This enables the LLM to reflect the particular persona or appear well-versed in the particular domain. In some implementations, the one or more instances of second LLM output can be considered a stream in that, as each word or phrase of the second NL based input is being processed using the LLM, the probability distribution over the sequence of words or phrases that are predicted to be responsive to the second NL based input can be continuously updated and with respect any previously selected segments for a stream of NL based output.

In some implementations, generating the one or more instances of second LLM output may include providing the second NL based input to a third party, e.g., using an application programming interface (API) call or web service request, for processing by the third party, using at least one LLM maintained by the third party. Responsive to providing the second NL based input, the third party may return the one or more instances of second LLM output, e.g., as a response to the API call or web service request.

At block 630, the system determines, based on the one or more instances of second LLM output, at least three responses to the second NL based input. For example, the system can cause the candidate segment engine 132 to determine, based on the probability distribution over the sequence of words or phrases, the at least three responses to the second NL based input. The candidate segment engine 132 can utilize matrix multiplication using the weights and/or parameters of the LLM to determine the at least three responses to the second NL based input. In some implementations, the at least three responses to the second NL based input can include a fixed number of responses. For instance, the fixed number of responses can include the three most likely responses including words or phrases that are predicted to be responsive to the second NL based input and based on the probability distribution for the words or phrases, the 10 most likely responses including words or phrases that are predicted to be responsive to the second NL based input and based on the probability distribution for the words or phrases, the 16 most likely responses including words or phrases that are predicted to be responsive to the second NL based input and based on the probability distribution for the words or phrases, and/or any other fixed number of responses. In other implementations, any number of responses corresponding to words or phrases that are associated with one or more probabilities from the probability distribution over the sequence of words or phrases that satisfy a threshold probability may be determined. In some implementations, the candidate segment engine 132 can store the candidate segments as they are determined in the candidate segment(s) database 132A.

In some implementations, at block 620, generating the one or more instances of second LLM output may include: processing the second NL based input, using a first LLM, to generate a first instance of the one or more instances of second LLM output; and processing the second NL based input, using a second LLM, to generate a second instance of the one or more instances of second LLM output. In these implementations, at block 630, determining the at least three responses to the second NL based input may include: determining, based on the first instance, a first response to the second NL based input; and determining, based on the second instance, a second response to the second NL based input.

In other implementations, at block 620, generating the one or more instances of second LLM output may include processing the second NL based input, using a first LLM, to generate a first instance of the one or more instances of second LLM output. In these implementations, at block 630, determining the at least three responses to the second NL based input may include: determining, based on the first instance, a first response to the second NL based input; determining, based on the first instance, a second response to the second NL based input; and determining, based on the first instance, a third response to the second NL based input.

In still other implementations, at block 620, generating the one or more instances of second LLM output may include: processing the second NL based input, using a first LLM, to generate a first instance of the one or more instances of second LLM output; modifying the second NL based input to generate modified NL based input; and processing the modified NL based input, using the first LLM, to generate a second instance of the one or more instances of second LLM output. In these implementations, at block 630, determining the at least three responses to the second NL based input may include: determining, based on the first instance, a first response to the second NL based input; and determining, based on the second instance, a second response to the second NL based input. In some implementations, modifying the second NL based input to generate the modified NL based input includes modifying the second NL based input to bias towards at least one response characteristic. In some implementations, the at least one response characteristic includes a tone (e.g., serious, sarcastic, silly, formal, informal, etc.) of a response. In some implementations, the at least one response characteristic includes a length of a response (e.g., 2-3 sentences, a longer paragraph, multiple paragraphs, etc.). In some implementations, the at least one response characteristic includes a complexity of a response (e.g., fourth grade reading level, college reading level, assuming no knowledge of topic, assuming expert-level knowledge of topic, etc.).

At block 640, the system modifies, based on the personalization signal, the at least one scoring criterion. In some implementations, the personalization signal is used in modifying the at least one scoring criterion, in response to identifying the personalization signal in response to receiving the user input indicating the user selection of the particular response.

In various implementations, the at least one scoring criterion may include an assurance criterion, an accuracy criterion, a quality criterion, and/or any other criteria. The assurance criterion can, for example, reflect a level of assurance or safety associated with each of the at least three responses. Put another way, the assurance criterion for each of the at least three responses can reflect a corresponding level of assurance for a user of the client device from which the second NL based input was received if the corresponding response was subsequently rendered at the client device. Further the accuracy criterion can, for example, reflect a level of accuracy or trustworthiness associated with each of the at least three responses in instances where the responses include factual information. Moreover, the quality criterion can, for example, reflect a corresponding quality score associated with each of the at least three responses. Although particular scoring criteria are described herein, it should be understood that these scoring criteria are provided for the sake of example and that any other suitable scoring criteria can be utilized.

At block 650, the system determines, based on the at least one modified scoring criterion, respective scores of the at least three responses to the second NL based input. For example, the system can cause the segment selection engine 133 to determine, based on the at least one modified scoring criterion, respective scores of the at least three responses to the second NL based input.

At block 660, the system selects, based on the respective scores of the at least three responses to the second NL based input, from the at least three responses to the second NL based input, a second subset, the second subset including at least two responses to the second NL based input. For example, the system can cause the segment selection engine 133 to select, based on the respective scores of the at least three responses to the second NL based input, a second subset, the second subset including at least two responses to the second NL based input. In some implementations, each response having a score satisfying a threshold may be included in the second subset. In other implementations, a number of highest-scoring responses may be included in the second subset. The number may be a predetermined number, a user-configurable number, or a dynamically determined number. The system can optionally store the responses in the second subset in one or more databases (e.g., the selected segment(s) database 133A).

At block 670, the system causes each of the at least two responses in the second subset to be rendered at the client device. In some implementations, the NL based output engine 140 may cause each of the at least two responses in the second subset to be transmitted to client device 110, and the rendering engine 112 may cause each of the at least two responses in the second subset to be rendered on the display 180.

For example, textual data corresponding to each of the at least two responses in the second subset can be transmitted to the client device for visual rendering via the display of the client device. In some versions of those implementations, the NL based output streaming engine 142 may cause the textual data corresponding to each of the at least two responses in the second subset can be rendered in a streaming manner, such as a on word-by-word basis, a segment-by-segment basis, and/or or in other streaming manners. In additional or alternative implementations, each of the at least two responses in the second subset can be audibly rendered via speaker(s) of the client device (e.g., via the rendering engine 112). In some versions of these implementations, textual data corresponding to the NL based output can be transmitted to the client device and the client device can process, using text-to-speech model(s), synthesized speech audio data to generate synthesized speech capturing the textual data corresponding to the stream of NL based output. The synthesized audio data can be audibly rendered via the speaker(s) of the client device. In other versions of those implementations, the synthesized speech audio data can be generated remotely from the client device (e.g., at a remote server in implementations where the system is hosted at the remote server), and the synthesized speech audio data can be transmitted to the client device and audibly rendered via the speaker(s) of the client device.

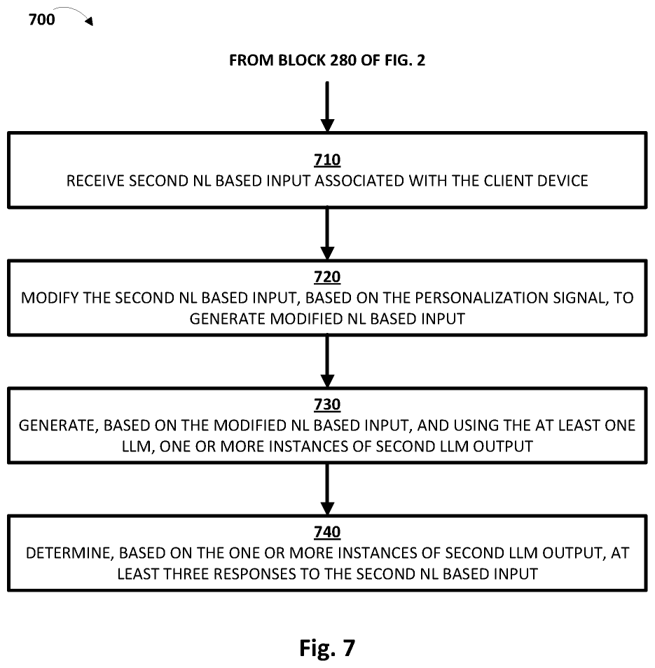

Turning now to FIG. 7, a flowchart illustrating an example method 700 for personalized multi-response dialog generated using a large language model is depicted. For convenience, the operations of the method 700 are described with reference to a system that performs the operations. This system of method 700 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 700 are shown in a particular order, this is not meant to be limiting. One or more operations may be reordered, omitted, and/or added.

In some implementations, after performing the operations at block 280 of FIG. 2, the flow may proceed to block 710 of FIG. 7. At block 710, the system receives second NL based input associated with the client device.

In some implementations, the second NL based input can be one formulated based on explicit user interface input at a client device (e.g., detected via the user input engine 111), such as typed input, voice input, input to cause an image to be captured or selected, etc. In some of those implementations, the second NL based input can be a query. The query can be, for example, a voice query, a typed query, an image-based query, or a multimodal query (e.g., that includes voice input, and an image or video). In some implementations, when the query includes content that is not in textual format, the system can convert the query to a textual format or other format. For example, if the query is a voice query, then the system can perform automatic speech recognition (ASR) to convert the query to textual format. As another example, if the query is a multimodal query that includes an image or video of an avocado and a voice input of “is this healthy”, then the system can perform ASR to convert the voice input to text form and can perform image or video processing on the image or video to recognize an avocado is present in the image or video, and can perform co-reference resolution to replace “this” with “an avocado”, resulting in a textual format query of “is an avocado healthy”.

In some implementations, the second NL based input can be received in an application environment of one or more software applications that are accessible at the client device, such as a browser software application, an automated assistant software application, etc. (e.g., via the application engine 115). In additional or alternative versions of those implementations, the system can augment the second NL based input (e.g., augment the explicit NL based input) with additional information, such as one or more past or current contexts of the client device and/or a user of the client device (e.g., via the context engine 113).

In other implementations, the second NL based input can alternatively be implied NL based input, such as an inferred/parameterless query, such as one formulated and/or submitted independent of any explicit user NL based input directed to formulating the implied NL based input (e.g., as described with respect to the context engine 113 and/or the implied input engine 114 of FIG. 1). For example, the query can be an implied query that is automatically generated based on profile data and that is automatically submitted. For instance, the implied NL based input can be an implied query of “machine learning”, based on profile data indicating interest in machine learning topic(s). As another example, the implied NL based input can be an implied query that is automatically generated and/or automatically submitted based on a current and/or recent context. As yet another example, the implied NL based input can be an implied query that is submitted based on the user providing some indication of a desire to perform a search (e.g., pushing a search button, performing a search touch gesture, accessing a particular screen or state of an application), but that is generated automatically based on content currently being displayed at a client device, location, time of day, and/or other context signal(s).

At block 720, the system modifies the second NL based input, based on the personalization signal, to generate modified NL based input. In some implementations, the NL based output system 120 may modify the second NL based input based on the personalization signal. For example, the NL based output system 120 may modify the second NL based input, based on the personalization signal, to bias towards at least one response characteristic.

At block 730, the system generates, based on the modified NL based input, and using the at least one LLM, one or more instances of second LLM output. For example, the system can cause the LLM engine 131 to process, using at least one LLM stored in the LLM(s) database 131A, the modified NL based input to generate one or more instances of second LLM output. The at least one LLM can include, for example, any LLM that is stored in the LLM(s) database 131A, such as PaLM, BERT, LaMDA, Meena, GPT-3, GPT-4, ChatGPT, and/or any other LLM. In other implementations, one or more of the at least one LLM may be a specially-tuned LLM, such as a search-result tuned LLM that is tuned based on a search result index and, an advertising-tuned LLM that is tuned based on advertising content, and/or any other specially-tuned LLM. Further, the one or more instances of second LLM output can include, for example, a probability distribution over a sequence of words or phrases that are predicted to be responsive to the second NL based input. Notably, each of the at least one LLM can include billions of weights and/or parameters that are learned through training the LLM on enormous amounts of diverse data. This enables the LLM to generate the one or more instances of the second LLM output as the probability distribution over the sequence of words or phrases. In some implementations, the sequence of words or phrases corresponds to a vocabulary. In some versions of these implementations, the vocabulary can optionally be restricted to that of a particular persona or a particular domain. This enables the LLM to reflect the particular persona or appear well-versed in the particular domain. In some implementations, the one or more instances of second LLM output can be considered a stream in that, as each word or phrase of the modified NL based input is being processed using the LLM, the probability distribution over the sequence of words or phrases that are predicted to be responsive to the modified NL based input can be continuously updated and with respect any previously selected segments for a stream of NL based output.

In some implementations, generating the one or more instances of second LLM output may include providing the modified NL based input to a third party, e.g., using an application programming interface (API) call or web service request, for processing by the third party, using at least one LLM maintained by the third party. Responsive to providing the modified NL based input, the third party may return the one or more instances of second LLM output, e.g., as a response to the API call or web service request.

At block 740, the system determines, based on the one or more instances of second LLM output, at least three responses to the second NL based input. For example, the system can cause the candidate segment engine 132 to determine, based on the probability distribution over the sequence of words or phrases, the at least three responses to the second NL based input. The candidate segment engine 132 can utilize matrix multiplication using the weights and/or parameters of the LLM to determine the at least three responses to the second NL based input. In some implementations, the at least three responses to the second NL based input can include a fixed number of responses. For instance, the fixed number of responses can include the three most likely responses including words or phrases that are predicted to be responsive to the second NL based input and based on the probability distribution for the words or phrases, the 10 most likely responses including words or phrases that are predicted to be responsive to the second NL based input and based on the probability distribution for the words or phrases, the 16 most likely responses including words or phrases that are predicted to be responsive to the second NL based input and based on the probability distribution for the words or phrases, and/or any other fixed number of responses. In other implementations, any number of responses corresponding to words or phrases that are associated with one or more probabilities from the probability distribution over the sequence of words or phrases that satisfy a threshold probability may be determined. In some implementations, the candidate segment engine 132 can store the candidate segments as they are determined in the candidate segment(s) database 132A.

In some implementations, at block 730, generating the one or more instances of second LLM output may include: processing the modified NL based input, using a first LLM, to generate a first instance of the one or more instances of second LLM output; and processing the modified NL based input, using a second LLM, to generate a second instance of the one or more instances of second LLM output. In these implementations, at block 740, determining the at least three responses to the second NL based input may include: determining, based on the first instance, a first response to the second NL based input; and determining, based on the second instance, a second response to the second NL based input.

In other implementations, at block 730, generating the one or more instances of second LLM output may include processing the modified NL based input, using a first LLM, to generate a first instance of the one or more instances of second LLM output. In these implementations, at block 740, determining the at least three responses to the second NL based input may include: determining, based on the first instance, a first response to the second NL based input; determining, based on the first instance, a second response to the second NL based input; and determining, based on the first instance, a third response to the second NL based input.

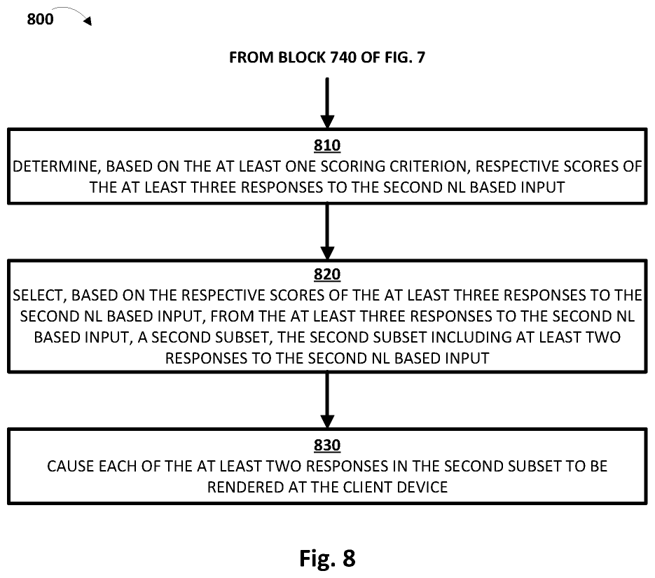

Turning now to FIG. 8, a flowchart illustrating an example method 800 for personalized multi-response dialog generated using a large language model is depicted. For convenience, the operations of the method 800 are described with reference to a system that performs the operations. This system of method 800 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 800 are shown in a particular order, this is not meant to be limiting. One or more operations may be reordered, omitted, and/or added.

In some implementations, after performing the operations at block 740 of FIG. 7, the flow may proceed to block 810 of FIG. 8. At block 810, the system determines, based on the at least one scoring criterion, respective scores of the at least three responses to the second NL based input. For example, the system can cause the segment selection engine 133 to determine, based on at least one scoring criterion, respective scores of the at least three responses to the second NL based input. In various implementations, the one or more scoring criterion may include an assurance criterion, an accuracy criterion, a quality criterion, and/or any other criteria. The assurance criterion can, for example, reflect a level of assurance or safety associated with each of the at least three responses. Put another way, the assurance criterion for each of the at least three responses can reflect a corresponding level of assurance for a user of the client device from which the second NL based input was received if the corresponding response was subsequently rendered at the client device. Further the accuracy criterion can, for example, reflect a level of accuracy or trustworthiness associated with each of the at least three responses in instances where the responses include factual information. Moreover, the quality criterion can, for example, reflect a corresponding quality score associated with each of the at least three responses. Although particular scoring criteria are described herein, it should be understood that these scoring criteria are provided for the sake of example and that any other suitable scoring criteria can be utilized.

In some implementations, the at least one scoring criterion includes a diversity measure that is based on a level of distinctiveness relative to other ones of the at least three responses to the second NL based input.

At block 820, the system selects, based on the respective scores of the at least three responses to the second NL based input, from the at least three responses to the second NL based input, a second subset, the second subset including at least two responses to the second NL based input. For example, the system can cause the segment selection engine 133 to select, based on the respective scores of the at least three responses to the second NL based input, a second subset, the second subset including at least two responses to the second NL based input. In some implementations, each response having a score satisfying a threshold may be included in the second subset. In other implementations, a number of highest-scoring responses may be included in the second subset. The number may be a predetermined number, a user-configurable number, or a dynamically determined number. The system can optionally store the responses in the second subset in one or more databases (e.g., the selected segment(s) database 133A).

At block 830, the system causes each of the at least two responses in the second subset to be rendered at the client device. In some implementations, the NL based output engine 140 may cause each of the at least two responses in the second subset to be transmitted to client device 110, and the rendering engine 112 may cause each of the at least two responses in the second subset to be rendered on the display 180.

For example, textual data corresponding to each of the at least two responses in the second subset can be transmitted to the client device for visual rendering via the display of the client device. In some versions of those implementations, the NL based output streaming engine 142 may cause the textual data corresponding to each of the at least two responses in the second subset can be rendered in a streaming manner, such as a on word-by-word basis, a segment-by-segment basis, and/or or in other streaming manners. In additional or alternative implementations, each of the at least two responses in the second subset can be audibly rendered via speaker(s) of the client device (e.g., via the rendering engine 112). In some versions of these implementations, textual data corresponding to the NL based output can be transmitted to the client device and the client device can process, using text-to-speech model(s), synthesized speech audio data to generate synthesized speech capturing the textual data corresponding to the stream of NL based output. The synthesized audio data can be audibly rendered via the speaker(s) of the client device. In other versions of those implementations, the synthesized speech audio data can be generated remotely from the client device (e.g., at a remote server in implementations where the system is hosted at the remote server), and the synthesized speech audio data can be transmitted to the client device and audibly rendered via the speaker(s) of the client device.

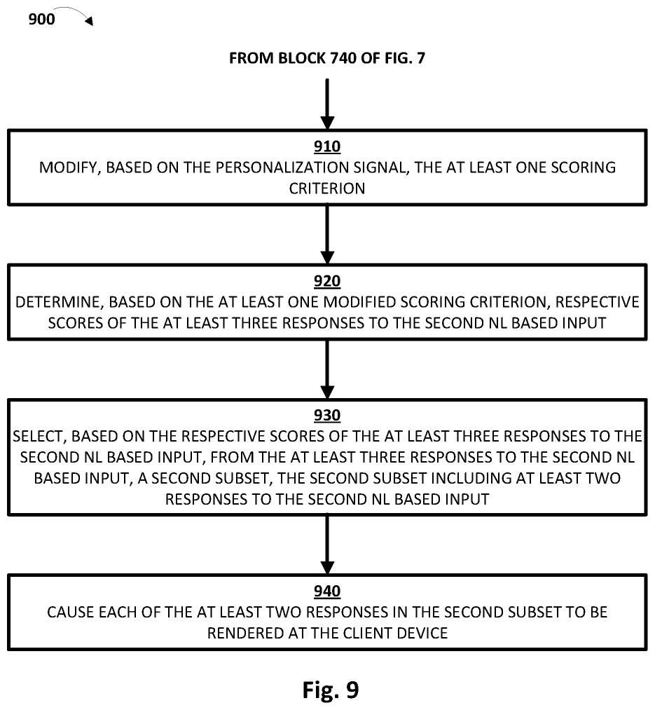

Turning now to FIG. 9, a flowchart illustrating an example method 900 for personalized multi-response dialog generated using a large language model is depicted. For convenience, the operations of the method 900 are described with reference to a system that performs the operations. This system of method 900 includes one or more processors, memory, and/or other component(s) of computing device(s) (e.g., client device 110 of FIGS. 1, 10, and 11, NL based output system 120 of FIG. 1, computing device 1210 of FIG. 12, one or more servers, and/or other computing devices). Moreover, while operations of method 900 are shown in a particular order, this is not meant to be limiting. One or more operations may be reordered, omitted, and/or added.

In some implementations, after performing the operations at block 740 of FIG. 7, the flow may proceed to block 910 of FIG. 9. At block 910, the system modifies, based on the personalization signal, the at least one scoring criterion. In some implementations, the personalization signal is used in modifying the at least one scoring criterion, in response to identifying the personalization signal in response to receiving the user input indicating the user selection of the particular response.

In various implementations, the at least one scoring criterion may include an assurance criterion, an accuracy criterion, a quality criterion, and/or any other criteria. The assurance criterion can, for example, reflect a level of assurance or safety associated with each of the at least three responses. Put another way, the assurance criterion for each of the at least three responses can reflect a corresponding level of assurance for a user of the client device from which the second NL based input was received if the corresponding response was subsequently rendered at the client device. Further the accuracy criterion can, for example, reflect a level of accuracy or trustworthiness associated with each of the at least three responses in instances where the responses include factual information. Moreover, the quality criterion can, for example, reflect a corresponding quality score associated with each of the at least three responses. Although particular scoring criteria are described herein, it should be understood that these scoring criteria are provided for the sake of example and that any other suitable scoring criteria can be utilized.

At block 920, the system determines, based on the at least one modified scoring criterion, respective scores of the at least three responses to the second NL based input. For example, the system can cause the segment selection engine 133 to determine, based on the at least one modified scoring criterion, respective scores of the at least three responses to the second NL based input.

At block 930, the system selects, based on the respective scores of the at least three responses to the second NL based input, from the at least three responses to the second NL based input, a second subset, the second subset including at least two responses to the second NL based input. For example, the system can cause the segment selection engine 133 to select, based on the respective scores of the at least three responses to the second NL based input, a second subset, the second subset including at least two responses to the second NL based input. In some implementations, each response having a score satisfying a threshold may be included in the second subset. In other implementations, a number of highest-scoring responses may be included in the second subset. The number may be a predetermined number, a user-configurable number, or a dynamically determined number. The system can optionally store the responses in the second subset in one or more databases (e.g., the selected segment(s) database 133A).

At block 940, the system causes each of the at least two responses in the second subset to be rendered at the client device. In some implementations, the NL based output engine 140 may cause each of the at least two responses in the second subset to be transmitted to client device 110, and the rendering engine 112 may cause each of the at least two responses in the second subset to be rendered on the display 180.

For example, textual data corresponding to each of the at least two responses in the second subset can be transmitted to the client device for visual rendering via the display of the client device. In some versions of those implementations, the NL based output streaming engine 142 may cause the textual data corresponding to each of the at least two responses in the second subset can be rendered in a streaming manner, such as a on word-by-word basis, a segment-by-segment basis, and/or or in other streaming manners. In additional or alternative implementations, each of the at least two responses in the second subset can be audibly rendered via speaker(s) of the client device (e.g., via the rendering engine 112). In some versions of these implementations, textual data corresponding to the NL based output can be transmitted to the client device and the client device can process, using text-to-speech model(s), synthesized speech audio data to generate synthesized speech capturing the textual data corresponding to the stream of NL based output. The synthesized audio data can be audibly rendered via the speaker(s) of the client device. In other versions of those implementations, the synthesized speech audio data can be generated remotely from the client device (e.g., at a remote server in implementations where the system is hosted at the remote server), and the synthesized speech audio data can be transmitted to the client device and audibly rendered via the speaker(s) of the client device.

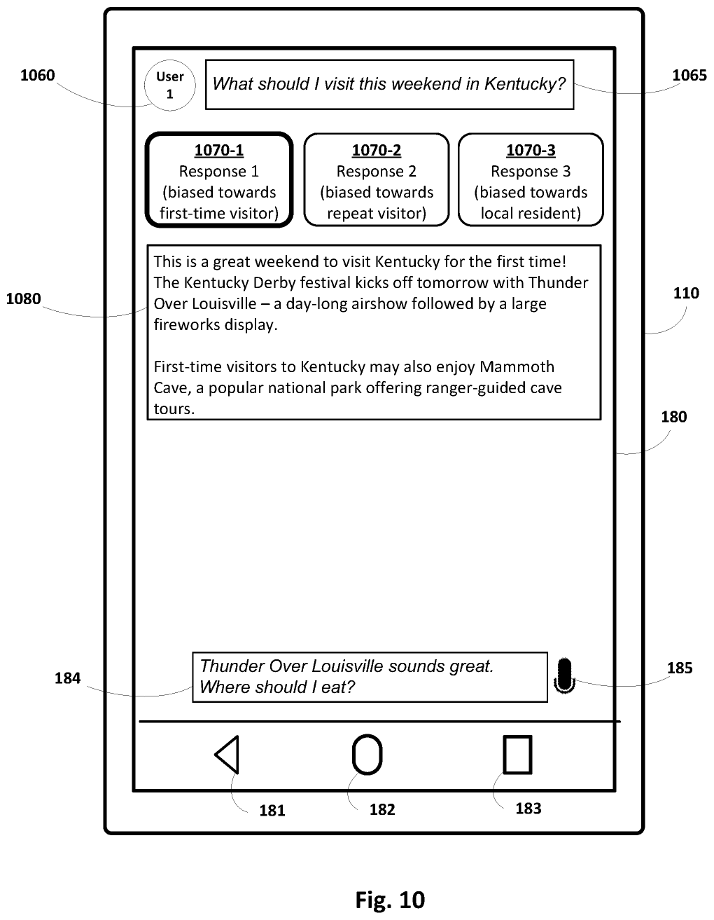

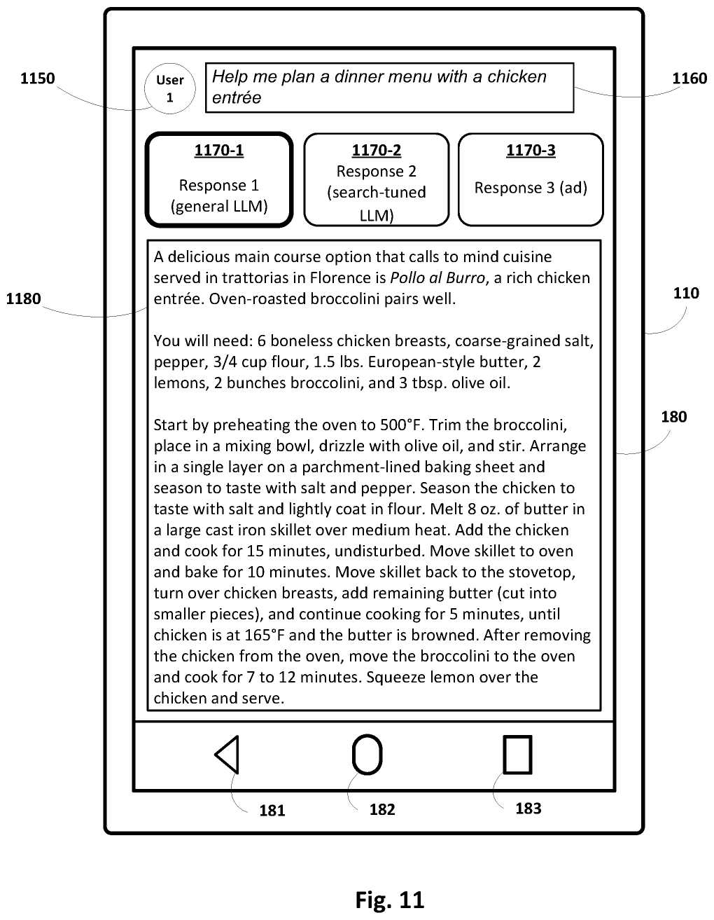

Turning now to FIGS. 10 and 11, non-limiting examples of a client device rendering a graphical interface that includes a personalized multi-response dialog generated using one or more LLMs are depicted. The client device 110 (e.g., the client device 110 from FIG. 1) may include various user interface components including, for example, microphone(s) to generate audio data based on spoken utterances and/or other audible input, speaker(s) to audibly render synthesized speech and/or other audible output, and/or a display 180 to visually render visual output. Further, the display 180 of the client device 110 can include various system interface elements 181, 182, and 183 (e.g., hardware and/or software interface elements) that may be interacted with by a user of the client device 110 to cause the client device 110 to perform one or more actions. The display 180 of the client device 110 enables the user to interact with content rendered on the display 180 by touch input (e.g., by directing user input to the display 180 or portions thereof (e.g., to a text entry box 184, to a keyboard (not depicted), or to other portions of the display 180)) and/or by spoken input (e.g., by selecting microphone interface element 185—or just by speaking without necessarily selecting the microphone interface element 185 (i.e., an automated assistant may monitor for one or more terms or phrases, gesture(s) gaze(s), mouth movement(s), lip movement(s), and/or other conditions to activate spoken input at the client device 110). Although the client device 110 depicted in FIGS. 10 and 11 is a mobile phone, it should be understood that is for the sake of example and is not meant to be limiting. For example, the client device 110 may be a standalone speaker with a display, a standalone speaker without a display, a home automation device, an in-vehicle system, a laptop, a desktop computer, and/or any other computing device.

Referring specifically to FIG. 10, assume that a user of the client device 110, indicated by the “User 1” icon 1060, previously directed NL based input 1065 of “What should I visit this weekend in Kentucky?” to an automated assistant executing at least in part at the client device 110. The NL based input 1065 may have been provided by the user, for example, by directing spoken input to the automated assistant (e.g., by selecting microphone interface element 185—or just by speaking without necessarily selecting the microphone interface element 185), and/or by typed input via the text entry box 184. Although the example of FIG. 10 is described with respect to the NL based input 1065 being directed to the automated assistant, it should be understood that is for the sake of example and is not meant to be limiting. For example, the NL based input 1065 can be directed to any software application that is accessible at the client device 110 (e.g., via the application engine 115) and capable of receiving the NL based input 1065 and causing two or more responses to the NL based input 1065 to be rendered at the client device 110, such as a web browser software application. Further, although the example of FIG. 10 is described with respect to the NL based input 1065 being based on explicit input provided by the user of the client device 110, it should be understood that is also for the sake of example and is not meant to be limiting. For example, the NL based input 1065 can be an implied NL based input (e.g., as described with respect to the implied input engine 114).

Further assume that the automated assistant, in generating two or more responses to the NL based input 1065, implements the method 200 of FIG. 2. For instance, responsive to the NL based input 1065 of “What should I visit this weekend in Kentucky?”, the candidate segment engine 132 may determine five responses to the NL based input 1065. In the example of FIG. 10, the NL based output system 120 may modify the NL based input 1065, e.g., to bias towards at least one response characteristic, to generate first modified NL based input, second modified NL based input, third modified NL based input, fourth modified NL based input, and fifth modified NL based input. In this example, the first modified NL based input may be biased towards a first-time visitor (e.g., the first modified NL based input may be, “What should I visit this weekend in Kentucky? I'm a first time visitor.”), the second modified NL based input may be biased towards a repeat visitor (e.g., the second modified NL based input may be, “What should I visit this weekend in Kentucky? I'm a repeat visitor.”), and the third modified NL based input may be biased towards a local resident (e.g., the third modified NL based input may be, “What should I visit this weekend in Kentucky? I'm a resident.”). In some implementations, the personalization engine 116 may modify the NL based input 1065 based on known attributes associated with a user (e.g., the user is a first-time visitor).

The first modified NL based input, the second modified NL based input, the third modified NL based input, the fourth modified NL based input, and the fifth modified NL based input may then be processed using an LLM to generate a first instance of LLM output, a second instance of LLM output, a third instance of LLM output, a fourth instance of LLM output, and a fifth instance of LLM output, respectively. The candidate segment engine 132 may then determine a first response to the NL based input 1065 based on the first instance, a second response to the NL based input 1065 based on the second instance, a third response to the NL based input 1065 based on the third instance, a fourth response to the NL based input 1065 based on the fourth instance, and a fifth response to the NL based input 1065 based on the fifth instance.

The segment selection engine 133 may then determine respective scores of the five responses to the NL based input 1065 and, based on the respective scores, select, from the five responses, a subset including three responses to the NL based input 1065. In some implementations, the segment selection engine 133 may use information provided by the personalization engine 116 in determining the respective scores of the five responses to the NL based input 1065. For example, based on information from the personalization engine 116 indicating that the user is a first-time visitor, a response to the NL based input 1065 that assumes the user is a first-time visitor may be scored higher than a response to the NL based input 1065 that assumes the user is a local resident. This may affect which response is shown first and/or whether a particular response is shown at all. In the example of FIG. 10, the first response (“Response 1”), the second response (“Response 2”), and the third response (“Response 3”) may be selected, e.g., based on having the three highest scores among the five responses. Each of the three responses in the subset may then be rendered at the client device 110. For instance, NL based output engine 140 may cause the three responses in the subset to be transmitted to client device 110, and the rendering engine 112 may cause the three responses in the subset to be rendered on the display 180.

In the example of FIG. 10, the three responses to the NL based input 1065 are indicated by box 1070-1 (“Response 1”), box 1070-2 (“Response 2”), and box 1070-3 (“Response 3”). Each of boxes 1070-1, 1070-2, and 1070-3 may further include an indication regarding a distinguishing characteristic of the respective response associated therewith. In particular, in the example of FIG. 10, box 1070-1 includes text indicating that Response 1 is biased towards a first-time visitor; box 1070-2 includes text indicating that Response 2 is biased towards a repeat visitor; and box 1070-3 includes text indicating that Response 3 is biased towards a local resident. In some implementations, the rendering engine 112 may use metadata included with the responses, transmitted by the NL based output engine 140 to the client device 110, to identify and/or determine the indications regarding distinguishing characteristics associated with the responses. In other implementations, instead of or in addition to the indications regarding distinguishing characteristics associated with the responses, each of boxes 1070-1, 1070-2, and 1070-3 may include a preview (e.g., a first few lines) of the respective response associated therewith.

A visual indication may be provided to indicate a selected box of the boxes 1070-1, 1070-2, and 1070-3. In the example of FIG. 10, a border of box 1070-1 is thickened (bolded) to indicate that box 1070-1 is selected. The response (i.e., Response 1 in the example of FIG. 10) associated with the selected box (i.e., box 1070-1 in the example of FIG. 10) may be displayed in output box 1080. In response to user input indicating a selection of a different response, a visual indication (e.g., a bolded outline) may be provided to indicate selection of a different box (e.g., box 1070-2 or box 1070-3). The user input indicating a selection of a different response may include a click or a tap on box 1070-2 or box 1070-3. In response to receiving the user input indicating a selection of a different response, output box 1080 may be updated to instead display the response associated with the selection of the different box (e.g., Response 2 in the case of box 1070-2 or Response 3 in the case of box 1070-3). Alternatively, by tapping on the text entry box 184, without providing any user input indicating a selection of a different response, a user may indicate a selection of Response 1, which is an initially selected (default) response.

In other implementations, a different user interface may be provided for displaying the subset including the three responses (or any other number of responses) to the NL based input 1065. For example, the different user interface may allow a user to scroll between the various responses in the subset (e.g., using a mouse) or may allow a user to swipe between the various responses in the subset.

In the example of FIG. 10, subsequent to indicating a user selection of Response 1 (e.g., by tapping on the text entry box 184), a user may provide further NL based input in the text entry box 184 (e.g., “Thunder Over Louisville sounds great. Where should I eat?”). In some implementations, the context going forward is based on these selections (e.g., the user selection of Response 1). For example, a history may be updated based on these selections. In response to receiving this user input, the personalization engine 116 may identify a personalization signal based on the selected response. In the example of FIG. 10, the personalization signal may be based on the distinguishing characteristic associated with Response 1 (e.g., the bias towards “first-time visitor”, as indicated by metadata included with Response 1). The personalization engine 116 may use this personalization signal to build and/or train a personalization model associated with User 1. This personalization model may be stored in the client device data 110A and may be used in generating responses to the further NL based input in the text entry box 184 (e.g., “Thunder Over Louisville sounds great. Where should I eat?”). For example, responses to the further NL based input may also be biased towards a first-time visitor.

Turning now to FIG. 11, an example is provided of another implementation in which, in addition to providing one or more responses to NL based input, the responses being determined using output(s) of one or more LLMs, one or more additional responses are also provided. These additional responses may be determined using output of an LLM tuned to provide search-result related output and/or an LLM tuned to provide advertising-related output. Additionally, or alternatively, these additional responses may be determined without the use of an LLM. For example, these additional responses may be determined using a search engine and/or using an advertising engine.

In the example of FIG. 11, assume that a user of the client device 110, indicated by the “User 1” icon 1150, previously directed NL based input 1160 of “Help me plan a dinner menu with a chicken entrée” to an automated assistant executing at least in part at the client device 110. The NL based input 1160 may have been provided by the user, for example, by directing spoken input to the automated assistant (e.g., by selecting microphone interface element 185 shown in FIG. 10—or just by speaking without necessarily selecting the microphone interface element 185), and/or by typed input via the text entry box 184 shown in FIG. 10. Although the example of FIG. 11 is described with respect to the NL based input 1160 being directed to the automated assistant, it should be understood that is for the sake of example and is not meant to be limiting. For example, the NL based input 1160 can be directed to any software application that is accessible at the client device 110 (e.g., via the application engine 115) capable of receiving the NL based input 1160 and causing two or more responses to the NL based input 1160 to be rendered at the client device 110, such as a web browser software application. Further, although the example of FIG. 11 is described with respect to the NL based input 1160 being based on explicit input provided by the user of the client device 110, it should be understood that is also for the sake of example and is not meant to be limiting. For example, the NL based input 1160 can be an implied NL based input (e.g., as described with respect to the implied input engine 114).

Further assume that the automated assistant, in generating responses to the NL based input 1160, implements the method 200 of FIG. 2. For instance, responsive to the NL based input 1160 of “Help me plan a dinner menu with a chicken entrée”, the candidate segment engine 132 may determine three responses to the NL based input 1160. The segment selection engine 133 may then determine respective scores of the three responses to the NL based input 1160 and, based on the respective scores, select, from the three responses, a subset including two responses to the NL based input 1160. In the example of FIG. 11, the first response (“Response 1”) and the second response (“Response 2”) may be selected, e.g., based on having the two highest scores among the three responses. Each of the two responses in the subset may then be rendered at the client device 110. For instance, NL based output engine 140 may cause the two responses in the subset to be transmitted to client device 110, and the rendering engine 112 may cause the three responses in the subset to be rendered on the display 180. Additionally, an advertising response (“Response 3”) may be generated by the NL output system 120 (e.g., using an advertising engine, and without the use of an LLM), transmitted to the client device 110, and rendered on the display 180 by the rendering engine 112.

In the example of FIG. 11, the responses to the NL based input 1160 are indicated by box 1170-1 (“Response 1”), box 1170-2 (“Response 2”), and box 1170-3 (“Response 3”). Each of boxes 1170-1, 1170-2, and 1170-3 may further include an indication regarding a distinguishing characteristic of the respective response associated therewith. In particular, in the example of FIG. 11, box 1170-1 includes text indicating that Response 1 is generated using a general LLM; box 1170-2 includes text indicating that Response 2 is generated using a search-result tuned LLM; and box 1170-3 includes text indicating that Response 3 is generated using an advertising engine. In some implementations, the rendering engine 112 may use metadata included with the responses, transmitted by the NL based output engine 140 to the client device 110, to identify and/or determine the indications regarding distinguishing characteristics associated with the responses. In other implementations, instead of or in addition to the indications regarding distinguishing characteristics associated with the responses, each of boxes 1170-1, 1170-2, and 1170-3 may include a preview (e.g., a first few lines) of the respective response associated therewith.

A visual indication may be provided to indicate a selected box of the boxes 1170-1, 1170-2, and 1170-3. In the example of FIG. 11, a border of box 1170-1 is thickened (bolded) to indicate that box 1170-1 is selected. The response (i.e., Response 1 in the example of FIG. 11) associated with the selected box (i.e., box 1170-1 in the example of FIG. 11) may be displayed in output box 1180. In response to user input indicating a selection of a different response, a visual indication (e.g., a bolded outline) may be provided to indicate selection of a different box (e.g., box 1170-2 or box 1170-3). The user input indicating a selection of a different response may include a click or a tap on box 1170-2 or box 1170-3. In response to receiving the user input indicating a selection of a different response, output box 1180 may be updated to instead display the response associated with the selection of the different box (e.g., Response 2 in the case of box 1170-2 or Response 3 in the case of box 1170-3). Alternatively, by tapping on the text entry box 184 (not visible in FIG. 11), without providing any user input indicating a selection of a different response, a user may indicate a selection of Response 1, which is an initially selected (default) response.

Turning now to FIG. 12, a block diagram of an example computing device 1210 that may optionally be utilized to perform one or more aspects of techniques described herein is depicted. In some implementations, one or more of a client device, cloud-based automated assistant component(s) or other cloud-based software application component(s), and/or other component(s) may comprise one or more components of the example computing device 1210.

Computing device 1210 typically includes at least one processor 1214 which communicates with a number of peripheral devices via bus subsystem 1212. These peripheral devices may include a storage subsystem 1224, including, for example, a memory subsystem 1225 and a file storage subsystem 1226, user interface output devices 1220, user interface input devices 1222, and a network interface subsystem 1216. The input and output devices allow user interaction with computing device 1210. Network interface subsystem 1216 provides an interface to outside networks and is coupled to corresponding interface devices in other computing devices.

User interface input devices 1222 may include a keyboard, pointing devices such as a mouse, trackball, touchpad, or graphics tablet, a scanner, a touch screen incorporated into the display, audio input devices such as voice recognition systems, microphones, and/or other types of input devices. In general, use of the term “input device” is intended to include all possible types of devices and ways to input information into computing device 1210 or onto a communication network.

User interface output devices 1220 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 1210 to the user or to another machine or computing device.

Storage subsystem 1224 stores programming and data constructs that provide the functionality of some or all of the modules described herein. For example, the storage subsystem 1224 may include the logic to perform selected aspects of the methods disclosed herein, as well as to implement various components depicted in FIG. 1.

These software modules are generally executed by processor 1214 alone or in combination with other processors. Memory 1225 used in the storage subsystem 1224 can include a number of memories including a main random access memory (RAM) 1230 for storage of instructions and data during program execution and a read only memory (ROM) 1232 in which fixed instructions are stored. A file storage subsystem 1226 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 1226 in the storage subsystem 1224, or in other machines accessible by the processor(s) 1214.

Bus subsystem 1212 provides a mechanism for letting the various components and subsystems of computing device 1210 communicate with each other as intended. Although bus subsystem 1212 is shown schematically as a single bus, alternative implementations of the bus subsystem 1212 may use multiple busses.

Computing device 1210 can be of varying types including a workstation, server, computing cluster, blade server, server farm, or any other data processing system or computing device. Due to the ever-changing nature of computers and networks, the description of computing device 1210 depicted in FIG. 12 is intended only as a specific example for purposes of illustrating some implementations. Many other configurations of computing device 1210 are possible having more or fewer components than the computing device depicted in FIG. 12.

In situations in which the systems described herein collect or otherwise monitor personal information about users, or may make use of personal and/or monitored information), the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented by one or more processors, the method comprising:
receiving first natural language (NL) based input associated with a client device;
generating, based on the first NL based input and using at least one large language model (LLM), one or more instances of first LLM output;
determining, based on the one or more instances of first LLM output, at least three responses to the first NL based input;
determining, based on at least one scoring criterion, respective scores of the at least three responses to the first NL based input;
selecting, based on the respective scores of the at least three responses to the first NL based input, from the at least three responses to the first NL based input, a first subset, the first subset comprising at least two responses to the first NL based input; and
causing each of the at least two responses in the first subset to be rendered at the client device.

2. The method according to claim 1, further comprising:
receiving user input associated with the client device, the user input indicating a user selection of a particular response, the user selection being from among the first subset and being in response to rendering of the first subset at the client device; and
in response to receiving the user input indicating the user selection of the particular response, identifying a personalization signal based on the particular response.

3. The method according to claim 2, further comprising:
receiving second NL based input associated with the client device;
generating, based on the personalization signal and the second NL based input, and using the at least one LLM, one or more instances of second LLM output; and
determining, based on the one or more instances of second LLM output, at least three responses to the second NL based input,
wherein the personalization signal is used, along with the second NL based input, in generating the one or more instances of second LLM output, in response to identifying the personalization signal in response to receiving the user input indicating the user selection of the particular response.

4. The method according to claim 3, further comprising:
determining, based on the at least one scoring criterion, respective scores of the at least three responses to the second NL based input;
selecting, based on the respective scores of the at least three responses to the second NL based input, from the at least three responses to the second NL based input, a second subset, the second subset comprising at least two responses to the second NL based input; and
causing each of the at least two responses in the second subset to be rendered at the client device.

5. The method according to claim 3, further comprising:
modifying, based on the personalization signal, the at least one scoring criterion;
determining, based on the at least one modified scoring criterion, respective scores of the at least three responses to the second NL based input;
selecting, based on the respective scores of the at least three responses to the second NL based input, from the at least three responses to the second NL based input, a second subset, the second subset comprising at least two responses to the second NL based input; and
causing each of the at least two responses in the second subset to be rendered at the client device.

6. The method according to claim 2, further comprising:
receiving second NL based input associated with the client device;
generating, based on the second NL based input, and using the at least one LLM, one or more instances of second LLM output;
determining, based on the one or more instances of second LLM output, at least three responses to the second NL based input;
modifying, based on the personalization signal, the at least one scoring criterion;
determining, based on the at least one modified scoring criterion, respective scores of the at least three responses to the second NL based input;
selecting, based on the respective scores of the at least three responses to the second NL based input, from the at least three responses to the second NL based input, a second subset, the second subset comprising at least two responses to the second NL based input; and
causing each of the at least two responses in the second subset to be rendered at the client device,
wherein the personalization signal is used in modifying the at least one scoring criterion, in response to identifying the personalization signal in response to receiving the user input indicating the user selection of the particular response.

7. The method according to claim 2, further comprising:
receiving second NL based input associated with the client device;
modifying the second NL based input, based on the personalization signal, to generate modified NL based input;
generating, based on the modified NL based input, and using the at least one LLM, one or more instances of second LLM output; and
determining, based on the one or more instances of second LLM output, at least three responses to the second NL based input.

8. The method according to claim 7, further comprising:
determining, based on the at least one scoring criterion, respective scores of the at least three responses to the second NL based input;
selecting, based on the respective scores of the at least three responses to the second NL based input, from the at least three responses to the second NL based input, a second subset, the second subset comprising at least two responses to the second NL based input; and
causing each of the at least two responses in the second subset to be rendered at the client device.

9. The method according to claim 7, further comprising:
modifying, based on the personalization signal, the at least one scoring criterion;
determining, based on the at least one modified scoring criterion, respective scores of the at least three responses to the second NL based input;
selecting, based on the respective scores of the at least three responses to the second NL based input, from the at least three responses to the second NL based input, a second subset, the second subset comprising at least two responses to the second NL based input; and
causing each of the at least two responses in the second subset to be rendered at the client device.

10. The method according to claim 1, wherein:
generating the one or more instances of first LLM output comprises:
processing the first NL based input, using a first LLM, to generate a first instance of the one or more instances of first LLM output; and
processing the first NL based input, using a second LLM, to generate a second instance of the one or more instances of first LLM output; and
determining the at least three responses to the first NL based input comprises:
determining, based on the first instance, a first response to the first NL based input; and
determining, based on the second instance, a second response to the first NL based input.

11. The method according to claim 1, wherein:
generating the one or more instances of first LLM output comprises processing the first NL based input, using a first LLM, to generate a first instance of the one or more instances of first LLM output; and
determining the at least three responses to the first NL based input comprises:
determining, based on the first instance, a first response to the first NL based input;
determining, based on the first instance, a second response to the first NL based input; and
determining, based on the first instance, a third response to the first NL based input.

12. The method according to claim 1, wherein:
generating the one or more instances of first LLM output comprises:
processing the first NL based input, using a first LLM, to generate a first instance of the one or more instances of first LLM output;
modifying the first NL based input to generate modified NL based input; and
processing the modified NL based input, using the first LLM, to generate a second instance of the one or more instances of first LLM output; and
determining the at least three responses to the first NL based input comprises:
determining, based on the first instance, a first response to the first NL based input; and
determining, based on the second instance, a second response to the first NL based input.

13. The method according to claim 1, wherein the at least one scoring criterion comprises a diversity measure that is based on a level of distinctiveness relative to other ones of the at least three responses to the first NL based input.

14. The method according to claim 1, further comprising:
receiving user input associated with the client device, the user input indicating a user selection of a modified response, the modified response selected by the user being a version of a response in the first subset that has been modified by the user, and the user selection being in response to rendering of the first subset at the client device; and
in response to receiving the user input indicating the user selection of the modified response, identifying a personalization signal based on the modified response.

15. The method according to claim 1, wherein determining the at least three responses to the first NL based input comprises identifying respective confidence measures for the at least three responses to the first NL based input.

16. The method according to claim 15, wherein the respective confidence measures for the at least three responses to the first NL based input are used in determining the respective scores of the at least three responses to the first NL based input.

17. The method according to claim 15, wherein the respective confidence measures for the at least two responses in the first subset are rendered at the client device.

18. The method according to claim 15, wherein causing each of the at least two responses in the first subset to be rendered at the client device comprises causing indications of respective characteristics associated with the at least two responses in the first subset to be rendered at the client device.

19. A computer program product comprising one or more non-transitory computer-readable storage media having program instructions collectively stored on the one or more computer-readable storage media, the program instructions executable to:
receive first natural language (NL) based input associated with a client device;
generate, based on the first NL based input and using at least one large language model (LLM), one or more instances of first LLM output;
determine, based on the one or more instances of first LLM output, at least three responses to the first NL based input;
determine, based on at least one scoring criterion, respective scores of the at least three responses to the first NL based input;
select, based on the respective scores of the at least three responses to the first NL based input, from the at least three responses to the first NL based input, a first subset, the first subset comprising at least two responses to the first NL based input; and
cause each of the at least two responses in the first subset to be rendered at the client device.

20. A system comprising:
a processor, a computer-readable memory, one or more computer-readable storage media, and program instructions collectively stored on the one or more computer-readable storage media, the program instructions executable to:
receive first natural language (NL) based input associated with a client device;
generate, based on the first NL based input and using at least one large language model (LLM), one or more instances of first LLM output;
determine, based on the one or more instances of first LLM output, at least three responses to the first NL based input;
determine, based on at least one scoring criterion, respective scores of the at least three responses to the first NL based input;
select, based on the respective scores of the at least three responses to the first NL based input, from the at least three responses to the first NL based input, a first subset, the first subset comprising at least two responses to the first NL based input; and
cause each of the at least two responses in the first subset to be rendered at the client device.
